(19) United States
(12) Patent Application Publication
(10) Pub. No.: US 2026/0107315 A1
(43) Pub. Date: Apr. 16, 2026

(54) Reporting Random Access Information for Events or Operations in Shared Channels

(71) Applicant: Telefonaktiebolaget LM Ericsson (publ), Stockholm (SE)

(72) Inventors: Marco Belleschi, Solna (SE); Ali Parichehrehteroujeni, Linköping (SE)

(21) Appl. No.: 18/993,097

(22) PCT Filed: Aug. 1, 2023
(86) PCT No.: PCT/SE2023/050764

§ 371 Date: Jan. 10, 2025

Related U.S. Application Data
(60) Provisional application No. 63/395,058, filed on Aug. 4, 2022.

(51) Int. Cl. H04W 74/0833; H04W 36/00; H04W 74/0808

(52) U.S. Cl. CPC H04W 74/0833; H04W 36/0079; H04W 74/0808

(57) ABSTRACT

Embodiments include methods for a user equipment (UE) configured to operate in unlicensed spectrum in a radio access network (RAN). Such methods include detecting an event or performing an operation involving one or more cells in the RAN. Detecting the event or performing the operation includes one or more uplink (UL) listen-before-talk (LBT) failures during random access (RA) procedures on a shared channel. Such methods include, in association with detecting the event or performing the operation, storing RA information associated with one or more RA procedures performed in respective one or more bandwidth parts (BWPs) of the one or more cells. Such methods include subsequently sending to a RAN node a message indicating the event or operation; the message includes the RA information. Other embodiments include complementary methods for a RAN node, as well as UEs and RAN nodes configured to perform such methods.

### TECHNICAL FIELD

The present disclosure relates generally to wireless networks, and more specifically to techniques for improving the capability of a radio access network (RAN) to diagnose causes of events or operations reported by user equipment (UEs), particularly random access problems due to listen-before-talk (LBT) failures in shared (or unlicensed) spectrum.

### BACKGROUND

Currently the fifth generation (5G) of cellular systems is being standardized within the Third-Generation Partnership Project (3GPP). 5G is developed for maximum flexibility to support many different use cases including enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

Although not shown, in some deployments the 5GC can be replaced by an Evolved Packet Core (EPC, 198), which conventionally has been used together with a Long-Term Evolution (LTE) Evolved UMTS RAN (E-UTRAN). In such deployments, gNBs (e.g., 100, 150) can connect to one or more Mobility Management Entities (MMEs) in the EPC via respective S1-C interfaces and to one or more Serving Gateways (SGWs) in EPC via respective NG-U interfaces.

In addition, the gNBs can be connected to each other via one or more Xn interfaces, such as Xn interface (140) between gNBs (100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells. In general, a DL “beam” is a coverage area of a network-transmitted reference signal (RS) that may be measured or monitored by a UE.

The NG-RAN is layered into a Radio Network Layer (RNL) and a Transport Network Layer (TNL). The NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, each gNB-DU can be connected to only one gNB-CU. The gNB-CU and its connected gNB-DU(s) are only visible to other gNBs and the 5GC as a gNB. In other words, the F1 interface is not visible beyond gNB-CU.

3GPP Rel-10 introduced support for channel bandwidths larger than 20 MHz in LTE networks. To remain compatible with UEs from earlier releases (e.g., LTE Rel-8), a wideband LTE Rel-10 carrier appears as multiple component carriers (CCs), each having the same structure as an LTE Rel-8 carrier. A Rel-10 UE can receive the multiple CCs based on Carrier Aggregation (CA). The CCs can also be considered “cells,” such that a UE in CA has one primary cell (PCell) and one or more secondary cells (SCells) that are referred to collectively as a “cell group.” LTE Rel-12 introduced dual connectivity (DC) whereby a UE is connected simultaneously to a master node (MN) that provides a master cell group (MCG) and a secondary node (SN) that provides a secondary cell group (SCG). NR includes support for CA and DC in Rel-15 and thereafter.

Self-Organizing Networks (SON) is an automation technology used to improve the planning, configuration, management, optimization, and healing of mobile RANs. SON functionality can broadly be categorized as either self-optimization or self-configuration. Self-optimization employs UE and network measurements to auto-tune the RAN. This occurs when RAN nodes are in an operational state, after the node's RF transmitter interface is switched on. Self-configuration operations include optimization and adaptation, which are typically performed before the RAN nodes are in operational state.

Self-configuration and self-optimization features for NR networks are described in 3GPP TS 38.300 (v16.5.0) and for LTE networks in 3GPP TS 36.300 (v16.5.0). These features include dynamic configuration, automatic neighbor relations (ANR), mobility load balancing (MLB), mobility robustness optimization (MRO), random access channel (RACH) optimization, capacity and coverage optimization (CCO), and mobility settings change.

Seamless mobility is a key feature of 3GPP radio access technologies (RATs). In general, a RAN (e.g., NG-RAN) configures a UE to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE to declare radio link failure (RLF) or handover failure (HOF). This can occur before the UE sends a measurement report in a source cell, before the UE receives a handover command to a target cell, shortly after the UE executes a successful handover to the target cell, or upon a HOF to the target cell (e.g., upon expiry of timer T304, started when the UE starts synchronization with the target cell).

An RLF reporting procedure was introduced as part of the mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). 3GPP Rel-17 introduced a successful handover report (SHR) whereby a UE reports various information about a successful handover to a target cell. Both RLF reports and SHRs can include information about the UE's random access towards the target cell.

License Assisted Access (LAA) is an LTE feature that uses unlicensed 5-GHz spectrum in combination with licensed spectrum to deliver a performance boost for mobile device users. LAA uses DL carrier aggregation (CA) to combine LTE in licensed and unlicensed bands to provide better data rates and a better user experience. For example, in LAA, the UE's PCell is in a licensed band while the UE's SCells can be in an unlicensed band. LAA uses a concept called Listen-before-talk (LBT) that dynamically selects 5-GHz-band channel(s) that is(are) not being used. As such, LBT is often referred to as clear channel assessment (CCA). If no clear channel is available, LAA will share a channel fairly with others.

NR Rel-16 includes a feature similar to LTE LAA, called NR-Unlicensed (NR-U). In contrast to LTE LAA, NR-U supports DC and standalone scenarios in which cooperative licensed spectrum is not available. In such scenarios, medium access control (MAC, e.g., random access) and scheduling procedures on unlicensed (or shared) spectrum are subject to the LBT failures. This was not the case for LTE LAA, since MAC and scheduling procedures were performed in the licensed spectrum where LBT is unnecessary.

As mentioned above, RLF reports can include information (e.g., RA information) about the UE's random access towards the target cell, such as when the RLF is due to random access problems. This allows the network to understand the problem the UE encountered during the random access procedure and possibly address it. In NR-U, a UE may declare RLF or HOF due to consistent uplink (UL) LBT failures resulting from random access procedures in multiple bandwidth parts (BWPs) of a target cell (e.g., PCell or PSCell). However, current 3GPP specifications do not allow the UE to report RA-information for all random access procedures (i.e., in all BWPs) that led to the consistent UL LBT failure, and does not specify how the UE should log such information. There are similar deficiencies for successful handover reporting. Without such information, the RAN is unable to understand the UE's random access situation that led to the reported success or failure.

An object of embodiments of the present disclosure is to improve reporting of RA information by UEs operating in unlicensed spectrum, such as by providing, enabling, and/or facilitating solutions to overcome exemplary problems summarized above and described in more detail below.

Embodiments include methods (e.g., procedures) for a UE configured to operate in unlicensed spectrum in a radio access network (RAN, e.g., E-UTRAN, NG-RAN).

These exemplary methods can include detecting an event or performing an operation involving one or more cells in the RAN, where detecting the event or performing the operation includes one or more UL LBT failures during RA procedures on a shared channel. These exemplary methods can also include, in association with detecting the event or performing the operation, storing RA information associated with one or more RA procedures performed in respective one or more BWPs of the one or more cells. These exemplary methods can also include subsequently sending to a RAN node a message indicating the event or operation, where the message includes the RA information.

In some embodiments, the event or operation is a failed mobility operation from a source cell to a target cell and the one or more UL LBT failures include one of the following: at least one consistent UL LBT failure in a BWP of the target cell, or more than a threshold number of UL LBT failures in the target cell during the failed mobility operation. In such case, the RA information is associated with one or more RA procedures performed in respective one or more BWPs of the target cell.

In some of these embodiments, the failed mobility operation is a dual-active protocol stack (DAPS) handover and the one or more UL LBT failures also include one of the following: at least one consistent UL LBT failure in a BWP of the source cell, or more than a threshold number of UL LBT failures in the source cell during the failed mobility operation. In such cases, the RA information is also associated with one or more RA procedures performed in respective one or more BWPs of the source cell.

In other embodiments, the event or operation is a radio-related failure in a serving cell and the one or more UL LBT failures include one of the following: at least one consistent UL LBT failure in a BWP of the serving cell, or more than a threshold number of UL LBT failures in the serving cell during the radio-related failure. In such cases, the RA information is associated with one or more RA procedures performed in respective one or more BWPs of the serving cell.

In other embodiments, the event or operation is a radio link failure (RLF) in a serving cell and the RA information is associated with a last one of multiple RA procedures the UE performed in one of the BWPs of the serving cell to recover from the RLF.

In various ones of these embodiments, the message is a UEInformationResponse message and the RA information is included a radio link failure (RLF) report information element of the message.

In other embodiments, the event or operation is a successful mobility operation from a source cell to a target cell and the one or more UL LBT failures include more than a threshold number of UL LBT failures in the target cell during the successful mobility operation. In such case, the RA information is associated with one or more RA procedures performed in respective one or more BWPs of the target cell.

In other embodiments, the event or operation is a successful mobility operation from a source cell to a target cell and the RA information is associated with a last one of multiple RA procedures the UE performed in one of the BWPs of the target cell.

In some of these embodiments, the successful mobility operation is a DAPS handover and the one or more UL LBT failures also include one of the following: at least one consistent UL LBT failure in a BWP of the target cell, or more than a threshold number of UL LBT failures in the source cell during the successful mobility operation. In such cases, the RA information is also associated with one or more RA procedures performed in respective one or more BWPs of the source cell.

In various ones of these embodiments, the message is a UEInformationResponse message and the RA information is included a successful handover report (SHR) information element of the message.

In other embodiments, the event or operation is a successful RA procedure in a serving cell and the one or more UL LBT failures include at least one consistent UL LBT failure in a BWP of the serving cell before the successful RA procedure. In such cases, the RA information is associated with one or more RA procedures performed in respective one or more BWPs of the serving cell. In some of these embodiments, the message is a UEInformationResponse message and the RA information is included a RA report information element of the message.

In various embodiments, the RA information can include one of the following:
RA information for an initial RA procedure performed in a cell before detecting the event or during the operation;
RA information for a final RA procedure performed in a cell before detecting the event or during the operation;
RA information for only RA procedures performed a cell due to consistent UL LBT failure in another BWP of the cell;
information for only RA procedures performed a cell since a most recent BWP switch in the cell; or
RA information for a plurality of RA procedures performed in a respective plurality of BWPs of a cell before detecting the event or during the operation.

In various embodiments, the RA information for each RA procedure includes one or more of the following information:
an identity of a BWP in which the RA procedure was performed;
an indication of whether the BWP was an initial BWP for the cell;
an indication of whether the BWP was a first active BWP for the cell;
an indication of whether the RA information was triggered by consistent LBT failure in another BWP of the cell;
an identity and/or a configuration of another BWP in the cell, in which a RA procedure was most recently performed before the RA procedure in the BWP;
time elapsed between the most recent RA procedure in another BWP and initiating the RA procedure in the BWP and;
time elapsed between the most recent BWP switch and initiating the RA procedure in the BWP;
for each RA transmission during the RA procedure, an indication of whether the transmission was blocked by LBT failure at lower layers;
time elapsed between different RA transmissions during the RA procedure; and
one or more LBT-specific configuration parameters for the BWP.

In some of these embodiments, the RA information can also include one or more of the following:
an indication that consistent UL LBT failure occurred in the one or more cells before detecting the event or during the operation; and
a number of consistent UL LBT failures that were triggered and not cancelled at MAC layer in the one or more cells before detecting the event or during the operation.

In some of these embodiments, the time elapsed between different transmissions during the RA procedure (e.g., as indicated in the RA information) include time elapsed between one or more of the following: consecutive msg1 transmissions, consecutive msg3 transmissions, consecutive msgA transmissions, a msg3 transmission and a most recent msg1 transmission, and a msg3 transmission and a most recent msgA transmission.

In some embodiments, these exemplary methods can also include sending to the RAN node an indication that the UE has stored RA information in association with the event or operation and receiving from the RAN node a request for the stored RA information. The message is sent by the UE in response to the request.

Other embodiments include exemplary methods (e.g., procedures) for a RAN node configured to serve UEs via a cell in unlicensed spectrum. In general, these exemplary methods can be complementary to the exemplary methods for a UE summarized above.

These exemplary methods can include receiving from a UE a message indicating an event detected by the UE or an operation performed by the UE. The event or operation includes one or more UL LBT failures by the UE during RA procedures on a shared channel. The message includes RA information associated with one or more RA procedures performed by the UE in respective one or more BWPs of one or more cells. These exemplary methods can also include, based on the RA information, adjusting one or more LBT configuration parameters for UEs in a cell served by the RAN node.

In various embodiments, the event or operation can include any of those summarized above for UE embodiments. The UL LBT failures and RA information can be configured and/or arranged in a similar way as summarized above for the respective types of events or operations. For example, the RA information can include any of the same information as summarized above for UE embodiments.

In some embodiments, adjusting one or more LBT configuration parameters for UEs based on the RA information can include the following operations:
determining one or more of the following information based on the RA information:
   BWPs in which the UE experienced consistent UL LBT failure;
   how many BWP switches were performed by the UE due to consistent UL LBT failures;
   one or more types of UE RA transmissions that resulted in UL LBT failures;
   which portion of the UE's reported LBT failures occurred during RA procedures in the shared channel; and
   adjusting RA configurations in BWPs in which the UE experienced consistent UL LBT failure, based on the determined information.

Other embodiments include UEs (e.g., wireless devices) and RAN nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such UEs and RAN nodes to perform operations corresponding to any of the exemplary methods described herein.

These and other embodiments described herein can provide various advantages, benefits, and/or solutions to problems. For example, based on RA information logged by a UE, the RAN can determine how many BWP switches due to consistent UL LBT failures a UE made before detecting the event or during performing the operation. Since UL LBT failures may have occurred in the RA procedure itself, the RAN can adjust and/or optimize RA performance in the respective BWPs in which the UE attempted RA. Based on the RA information, the RAN may also determine a specific RA transmission subject to UL LBT failures. In some embodiments, the RAN can also determine the respective portions of the UE's LBT failures that occurred in RA and in UL transmissions for other channels. In this manner, the RAN can adjust and/or optimize UL LBT and/or RA settings for UEs operating in the cell based on the RA information reported by UEs.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 is a block diagram illustrating self-organization network (SON) functionality.

FIG. 5 shows an exemplary ASN.1 data structure for an RA-Report-r17 information element (IE), according to some embodiments of the present disclosure.

FIG. 6 shows an exemplary ASN.1 data structure for an RLF-Report-r17 IE, according to some embodiments of the present disclosure.

FIG. 7 shows an exemplary ASN.1 data structure for a SuccessHO-Report-r17 IE, according to some embodiments of the present disclosure.

FIG. 8 shows a flow diagram of an exemplary method for a UE (e.g., wireless device), according to various embodiments of the present disclosure.

FIG. 9 shows a flow diagram of an exemplary method for a RAN node (e.g., base station, eNB, gNB, ng-eNB, etc.), according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

As briefly mentioned above, current approaches used for LTE and NR self-configuration/self-optimization features are reactive based on current network conditions and/or current UE traffic load. In other words, the current approaches adjust coverage, capacity, load, etc. in response to inputs indicating onset of a degradation in network performance, e.g., due to increased interference, resource utilization, user traffic, etc. However, there can be significant delays between the adjustments and their desired effects, during which the degradation in network performance will continue. This is discussed in more detail below after the following description of NR network architecture and protocols.

FIG. 2 shows another high-level view of an exemplary 5G network architecture, including an NG-RAN (299) and a 5GC (298). As shown in the figure, the NG-RAN can include gNBs (e.g., 210a,b) and ng-eNBs (e.g., 220a,b) that are interconnected with each other via respective Xn interfaces. The gNBs and ng-eNBs are also connected via the NG interfaces to the 5GC, more specifically to Access and Mobility Management Functions (AMFs, e.g., 230a,b) via respective NG-C interfaces and to User Plane Functions (UPFs, e.g., 240a,b) via respective NG-U interfaces. Moreover, the AMFs can communicate with Policy Control Functions (PCFs, e.g., 250a,b) and Network Exposure Functions (NEFs, e.g., 260a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one or more cells (e.g., 211a-b, 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both types of functionality.

5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

As briefly mentioned above, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

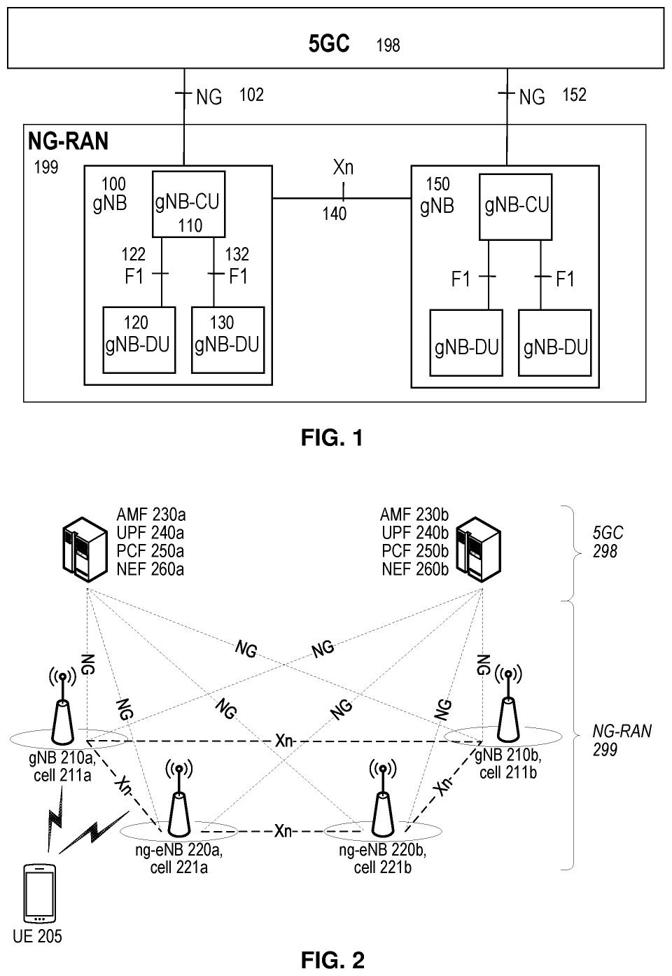

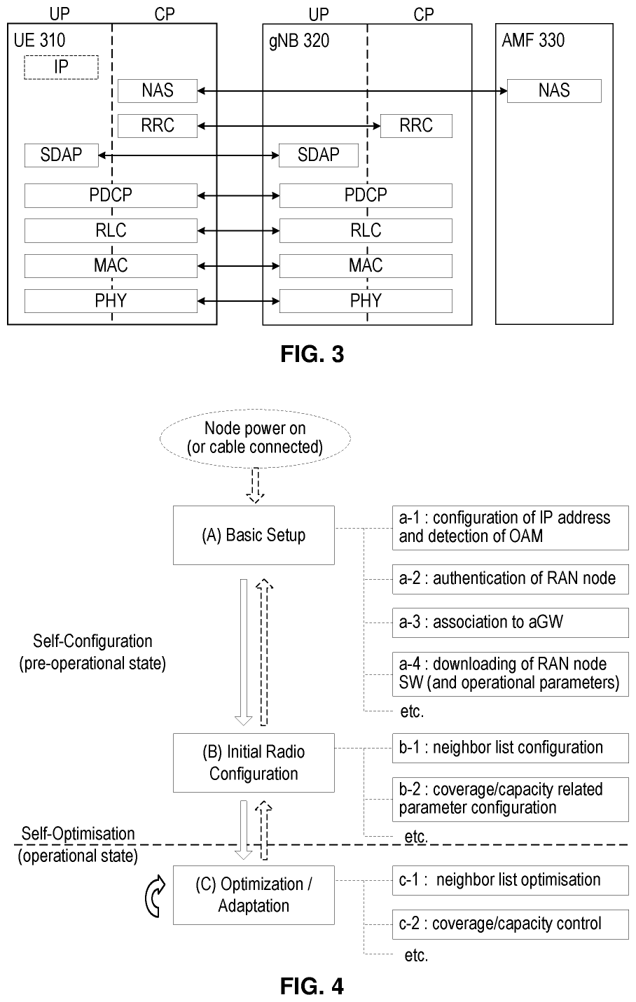

FIG. 3 shows an exemplary configuration of NR user plane (UP) and control plane (CP) protocol stacks between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between the UE and the gNB are common to UP and CP. PDCP provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (on gNB side). PHY provides transport channel services to MAC and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

As briefly mentioned above, 3GPP Rel-12 introduced LTE dual connectivity (DC) whereby a UE is connected simultaneously to a master node (MN) that provides a master cell group (MCG) and a secondary node (SN) that provides a secondary cell group (SCG). 3GPP TR 38.804 (v14.0.0) describes various exemplary DC scenarios or configurations in which the MN and SN can apply NR, LTE, or both.

Each cell group includes one MAC entity, a set of logical channels with associated RLC entities, a primary cell (PCell or PSCell), and optionally one or more secondary cells (SCells). The term “Special Cell” (or “SpCell” for short) refers to the PCell of the MCG or the PSCell of the SCG depending on whether the UE's MAC entity is associated with the MCG or the SCG. In non-DC operation (e.g., carrier aggregation), SpCell refers to the PCell. An SpCell is always activated and supports physical uplink control channel (PUCCH) transmission and contention-based random access by UEs.

Self-configuration is a pre-operational process in which newly deployed RAN nodes (e.g., eNBs or gNBs) in a pre-operational state are configured by automatic installation procedures to get the necessary basic configuration for system operation. Pre-operational state generally refers to the time when the node is powered up and has backbone connectivity until the node's RF transmitter is switched on. Self-configuration operations in pre-operational state include (A) basic setup and (B) initial radio configuration, which include the following sub-operations shown in FIG. 4:
(a-1) Configuration of IP address and detection of operations administration and maintenance (OAM);
(a-2) Authentication of RAN node;
(a-3) Associate to access gateway (aGW);
(a-4) Downloading of RAN node software (SW) and operational parameters;
(b-1) Neighbor list configuration; and
(b-2) Coverage/capacity-related parameter configuration.

Self-optimization is a process in which UE and network measurements are used to auto-tune the network. This occurs when the nodes are in operational state, which generally refers to when a node's RF transmitter interface is switched on. Self-configuration operations include optimization and adaptation, which includes the following sub-operations shown in FIG. 4:
(c-1) Neighbor list optimization; and
(c-2) Coverage/capacity control.

Self-configuration and self-optimization features for LTE networks are described in 3GPP TS 36.300 (v16.5.0) section 22.2. These include dynamic configuration, automatic neighbor relations (ANR), mobility load balancing (MLB), mobility robustness optimization (MRO), RACH optimization, and support for energy savings.

MLB involves coordination between two or more RAN nodes to optimize the traffic loads of their respective cells, thereby enabling a better use of radio resources available in a geographic area among served UEs. MLB can involve load-based handover of UEs between cells served by different nodes, thereby achieving “load balancing.”

CCO involves coordination between two or more RAN nodes to optimize the coverage and capacity offered by their respective cells. For example, a reduced coverage and/or capacity in a cell served by a first RAN node can be compensated by an increase in the coverage and/or capacity of neighboring cell served by a second RAN node.

Mobility settings change involves two RAN nodes negotiating a mutually agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. For example, a setting change for a handover trigger parameter can expand or shrink the UE's observed coverage area of a serving cell, thereby causing the UE to request a handover to a neighbor cell having a higher measured signal strength and/or quality.

Seamless mobility is a key feature of 3GPP radio access technologies (RATs). In general, a RAN (e.g., NG-RAN) configures a UE in RRC_CONNECTED state to perform and report radio resource management (RRM) measurements to assist network-controlled mobility decisions, such as for handover from a serving cell to a neighbor cell. Seamless handovers ensure that the UE moves around in the coverage area of different cells without excessive interruption to data transmission. However, there will be scenarios when the network fails to handover the UE to the “correct” neighbor cell in time, which can cause the UE will declare radio link failure (RLF) or handover failure (HOF).

A UE typically triggers an internal RLF procedure when something unexpected happens in any of these mobility-related procedures. The RLF procedure involves interactions between RRC and lower layer protocols such as PHY (or L1), MAC, RLC, etc. including radio link monitoring (RLM) on L1.

The principle of RLM is similar in LTE and NR. In general, the UE monitors link quality of the UE's serving cell and uses that information to decide whether the UE is in-sync (IS) or out-of-sync (OOS) with respect to that serving cell. If RLM (i.e., by L1/PHY) indicates number of consecutive OOS conditions to the RRC layer, then RRC starts an RLF procedure and declares RLF after expiry of a timer (e.g., T310). The L1 RLM procedure is carried out by comparing the estimated measurements to some targets Qout and Qin, which correspond to block error rates (BLERs) of hypothetical transmissions from the serving cell. Exemplary values of Qout and Qin are 10% and 2%, respectively. In NR, the network can define RS type (e.g., CSI-RS and/or SSB), exact resources to be monitored, and the BLER target for IS and OOS indications.

In case of handover failure (HOF) and RLF, the UE may take autonomous actions such as selecting a cell and initiating reestablishment to remain reachable by the network. In general, a UE declares RLF only when the UE realizes that there is no reliable radio link available between itself and the network, which can result in poor user experience. Also, reestablishing the connection requires signaling with a newly selected cell (e.g., random access procedure, exchanging various RRC messages, etc.), which introduces latency until the UE can again reliably transmit and/or receive user data with the network. Potential causes for RLF include:
1) Radio link problem indicated by PHY (e.g., expiry of RLM-related timer T310);
2) Random access problem indicated by MAC entity;
3) Expiry of a measurement reporting timer (e.g., T312), due to not receiving a HO command from the network while the timer is running despite sending a measurement report;
4) Reaching a maximum number of RLC retransmissions;
5) Consistent UL LBT failures while operating in unlicensed spectrum; and
6) Failing a beam failure recovery (BFR) procedure.
   On the other hand, HOF is caused by expiry of T304 timer while performing the handover to the target cell.

Since RLF leads to reestablishment in a new cell and degradation of UE/network performance and end-user experience, it is in the interest of the network to understand the reasons for UE RLF and to optimize mobility-related parameters (e.g., trigger conditions of measurement reports) to reduce, minimize, and/or avoid subsequent RLFs. Before Rel-9 mobility robustness optimizations (MRO), only the UE was aware of radio quality at the time of RLF, the actual reason for declaring RLF, etc.

An RLF reporting procedure was introduced as part of mobility robustness optimization (MRO) in LTE Rel-9. In this procedure, a UE logs relevant information at the time of RLF and later reports such information to the network via a target cell to which the UE ultimately connects (e.g., after reestablishment). The reported information can include RRM measurements of various neighbor cells prior to the mobility operation (e.g., handover). A corresponding RLF reporting procedure was introduced as part of MRO for NR Rel-16.

In this procedure, a UE logs relevant information at the time of RLF and later reports such information to the network via a target cell to which the UE ultimately connects (e.g., after reestablishment). The UE can store the RLF report in a UE variable call varRLF-Report and retains it in memory for up to 48 hours, after which it may discard the information.

When sending certain RRC messages such as RRCReconfigurationComplete, RRCReestablishmentComplete, RRCSetup-Complete, and RRCResumeComplete, the UE can indicate it has a stored RLF report by setting a rlf-InfoAvailable field to “true.” If the gNB serving the target cell wants to receive the RLF report, it sends the UE an UEInformationRequest message with a flag “rlf-ReportReq-r16”. In response, the UE sends the gNB an UEInformationResponse message that includes the RLF report.

In general, UE-reported RLF information can include any of the following:
Measurement quantities (RSRP, RSRQ) of the last serving cell (PCell).
Measurement quantities of the neighbor cells in different frequencies of different RATs (e.g., EUTRA, UTRA, GERAN, CDMA2000).
Measurement quantity (RSSI) associated to WLAN APs.
Measurement quantity (RSSI) associated to Bluetooth beacons.
Location information, if available (including location coordinates and velocity)
Globally unique identity of the last serving cell, if available, otherwise the PCI and the carrier frequency of the last serving cell.
Tracking area code of the PCell.
Time elapsed since the last reception of the ‘Handover command’ message.
C-RNTI used in the previous serving cell.
Whether or not the UE was configured with a DRB having QCI=1.

Based on a UE RLF report and knowledge of the cell in which the UE reestablished its connection, the RAN node serving the UE's original source cell can deduce whether the RLF was due to a coverage hole or handover-related parameter configurations. If the latter case, the RAN node serving the UE's original source cell can also classify the handover-related failure as too-early, too-late, or wrong-cell. These classes are described in more detail below.

The RAN node can classify a handover failure as “too late handover” when the original source cell fails to send the UE a command to handover to a particular target cell and if the UE ultimately reestablishes itself in this same target cell (i.e., post RLF). An example corrective action by the RAN node serving the UE's original source cell is to initiate handovers towards this target cell slightly earlier, such as by decreasing the cell individual offset (CIO) towards the target cell. Note that CIO controls when the UE sends the RAN node an event-triggered measurement report that causes the RAN node to make a handover decision.

The RAN node can classify a handover failure as ‘too early handover’ when the original source cell successfully to sends the UE a command to handover to a particular target cell but the UE fails to perform RA towards this target cell. An example corrective action by the RAN node serving the UE's original source cell is to initiate handovers towards this target cell slightly later, such as by increasing CIO to cause the UE to send the event-triggered measurement report slightly later.

The RAN node can classify a handover failure as “wrong cell handover” when the original serving cell intends to perform the handover for this UE towards a particular target cell but the UE instead declares RLF and reestablishes its connection in a different cell. Example corrective actions by the RAN node serving the UE's original source cell include initiating the UE measurement reporting procedure that leads to handover towards the target cell slightly later (e.g., by decreasing CIO for that cell) or initiating the handover towards the other cell in which the UE reestablished its connection slightly earlier (e.g., by increasing CIO for that cell).

NR Rel-15 introduced beam failure detection (BFD) and beam failure recovery (BFR). The serving RAN node configures a UE with BFD reference signals (e.g., SSB or CSI-RS) to be monitored, and the UE declares beam failure when a quantity of beam failure indications from L1 reaches a configured threshold before a configured timer expires. After BFD, the UE initiates a RA procedure in the serving cell and selects a suitable beam to perform BFR. In a multi-beam serving cell, RLF occurs when the UE is unable to find any suitable beam within the serving cell to recover the UE's failed connection. In contrast, RLF is prevented by the UE's successful BFR to another beam in the same cell.

3GPP Rel-17 introduced a successful handover report (SHR, also referred to as handover success report) that will be sent by UE to network upon successful execution of a handover command. In particular, 3GPP has defined an SHR configuration that a UE applies when in RRC_CONNECTED state to report information (e.g., measurements about a successful handover) under some specific conditions that are configured by the network.

For example, when any of timers T310/T312/T304 exceed corresponding thresholds during a handover, then the UE stores information associated with this handover. As another example, when the UE succeeded with a dual active protocol stack (DAPS) handover but experienced an RLF in the source cell, then the UE stores information associated with this handover. When storing the SHR, the UE may include various information to aid network analysis and optimization, such as measurements of the neighbouring cells, condition(s) that triggered the SHR (e.g., T310 threshold exceeded, RLF cause in the source cell during DAPS HO), etc.

The SHR can be configured by a RAN node serving the UE in a source cell and once triggering conditions are met, the UE stores relevant SHR information until requested by the RAN. In particular, the UE may indicate availability of SHR information in messages such as RRCReconfigurationComplete, RRCReestablishmentComplete, RRCSetupComplete, RRCResumeComplete, etc. The RAN may request SHR information via UEInformationRequest message and the UE provides the stored SHR via UEInformationResponse message.

As mentioned above, both SHR and RLF reports can include information (e.g., RA Information) about the UE's random access towards a target cell, such as when random access is the source of the RLF or triggered UE collection of SHR information. The RA information can include information about the BWP in which the RA was attempted, DL pathloss experienced at the time of initiating the RA procedure, information related to each RA preamble transmission attempt (e.g., whether contention was experienced, number of preamble transmission attempts in a certain SSB or CSI-RS, etc.). This allows the network to understand the UE's random access-related problem or issue and possibly address it.

Besides conventional use in licensed (i.e., exclusive) spectrum, NR networks also can operate in unlicensed bands in shared spectrum, referred to generally as NR-U. Operation in unlicensed bands introduces a unique set of rules intended to promote spectrum sharing with otherwise competing transceivers. These rules promote an etiquette or behavior that facilitates spectrum sharing and/or co-existence. According to a common coexistence technique, for a node (e.g., UE or base station) to be allowed to transmit in unlicensed spectrum, it typically needs to perform a listen-before-talk (LBT) or a clear channel assessment (CCA). For example, in the 5 GHz band, the sensing is done over 20-MHz channels. In general, the MAC layer initiates a transmission and requests the PHY layer to initiate the LBT procedure. After completion, the PHY layer indicates the LBT outcome (e.g., success or failure). This procedure can include sensing the medium as idle for a number of time intervals, which can be done in various ways including energy detection, preamble detection, or virtual carrier sensing.

LBT has become well-known and popular due to ubiquitous use by Wireless LANs (also known as “WiFi”), even though most regulatory agencies did not enforce LBT requirements. The introduction of LTE LAA and subsequent definition of LTE LAA regulations ensured LBT functionality was required by all radio transceivers, regardless of whether they were WiFi or LTE LAA. Energy detection (ED) thresholds were defined, simulated, debated, and soon became part of the regulatory specifications to be met by all devices that operate in unlicensed bands.

As an example of energy detection (ED), a channel is assessed to be idle when the received energy or power during the sensing time duration is below a certain ED threshold; otherwise, the channel is considered busy. Regulatory requirements in some regions specify the maximum allowed ED threshold, thus setting a limit on transmitter behavior. An example ED threshold is −72 dBm. In some cases, the ED threshold may depend on the channel bandwidth, e.g., −72 dBm 20 MHz bandwidth, −75 dBm for 10 MHz bandwidth, etc. If the channel is assessed as “busy” then the prospective transmitter (i.e., UE or network node) is required to defer transmission.

NR Rel-16 includes a feature similar to LTE LAA, called NR-Unlicensed (NR-U). In contrast to LTE LAA, NR-U supports DC and standalone scenarios in which cooperative licensed spectrum is not available. In such scenarios, medium access control (MAC, e.g., random access) and scheduling procedures on unlicensed spectrum are subject to the LBT failures. 3GPP TR 38.889 (v16.0.0) specifies the following four categories of channel access schemes for NR-U:
Cat-1 (also referred to as no LBT): Immediate transmission after a short switching gap. This is used for a transmitter to immediately transmit after a UL/DL switching gap inside a COT. The switching gap from reception to transmission is to accommodate the transceiver turnaround time and is no longer than 16 μs.
Cat-2 (also referred to as one shot LBT): LBT without random back-off. The duration of time that the channel is sensed to be idle before the transmitting entity transmits is deterministic.
Cat-3: LBT with random back-off with a contention window of fixed size. The transmitting entity draws a random number N within a contention window, whose size is fixed based on the minimum and maximum values of N. The random number N is used in the LBT procedure to determine the duration of time that the channel is sensed to be idle before the transmitting entity transmits on the channel.
Cat-4 (also referred to as dynamic channel occupancy with load based LBE): LBT with random back-off with a contention window of variable size. The transmitting entity draws a random number N within a contention window, whose size is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

Different categories of channel access schemes can be used for different transmissions in a COT and for different channels/signals to be transmitted. NR-U also supports two different LBT modes: dynamic channel occupancy for load based Equipment (LBE) and semi-static channel occupancy for frame based equipment (FBE).

In NR-U, a UE may declare RLF or HOF due to consistent uplink (UL) LBT failures resulting from RA procedures in multiple BWPs of a target cell (e.g., PCell or PSCell). The UE increments an LBT counter whenever an UL transmission fails in a certain BWP. When the LBT counter reaches a maximum value within a certain duration, the UE declares “consistent LBT failure” for the corresponding BWP. If the affected BWP is in the PCell or PSCell, the UE deactivates the affected BWP, activates another already configured BWP in the PCell/PSCell, and performs RA in the newly activated BWP. On the other hand, if the affected BWP is an SCell, the UE stops transmitting in the affected SCell and can transmit a scheduling request (SR) in another serving cell that has not experienced consistent UL LBT failures.

Additionally, the UE transmits a MAC CE to the RAN to indicate the cells in which consistent LBT failures occurred. Once the UE has attempted RA in all configured BWPs in the PCell with no success, the UE declares RLF and may attempt reestablishment. Similarly, the UE declares SCG failure when consistent UL LBT failures have occurred in all configured BWPs of the PSCell.

However, current 3GPP specifications such as 3GPP TS 38.331 (v17.1.0) do not allow the UE to report (e.g., in RLF report) the RA information for all random access procedures (i.e., in all BWPs) that resulted in consistent UL LBT failure and corresponding RLF/HOF. Likewise, current 3GPP specifications do not specify how the UE should log such information. There are similar deficiencies for successful handover reporting. Without such information, the RAN is unable to understand the UE's random access situation that led to the reported success or failure.

Accordingly, embodiments of the present disclosure provide flexible and efficient techniques whereby in association with a radio-related event, a UE logs (or stores) information associated with random access (RA) procedures performed in one or multiple BWPs of a cell (e.g., PCell, PSCell, or SpCell). The UE then sends the logged RA information in an appropriate report, such as an RLF report or an SHR sent in an RRC UEInformationResponse message. For example, the radio-related event can be any of the following:
an RLF in the SpCell (i.e., PCell or SpCell), after experiencing at least a consistent UL LBT failure in the SpCell,
a HOF (i.e., T304 timer expires), after experiencing at least one consistent UL LBT failure event during the handover;
a successful handover, after experiencing at least a certain number of UL LBT failures during the handover; and
a successful RA procedure, after experiencing a consistent UL LBT failure in the SpCell.

Embodiments of the present disclosure can provide various advantages, benefits, and/or solutions to problems. For example, based on RA information logged by a UE, the RAN can determine how many BWP switches due to consistent LBT failures a UE made before detecting the event or during performing the operation. Since LBT failures may have occurred in the RA procedure itself, the RAN can adjust and/or optimize RA performance in the respective BWPs in which the UE attempted RA. Based on the RA information, the RAN may also determine a specific RA transmission subject to LBT failures. In some embodiments, the RAN can also determine the respective portions of the UE's LBT failures that occurred in RA and in UL transmissions for other channels. In this manner, the RAN can adjust and/or optimize LBT and/or RA settings for UEs operating in the cell based on the RA information reported by UEs.

Some embodiments of the present disclosure involve procedures performed by a UE while operating in unlicensed spectrum in a RAN. In these embodiments, the UE can experience, declare, or detect one of the following events:
a failed mobility operation involving a source cell and a target cell (e.g., HOF upon T304 timer expiration) after experiencing one of the following: 1) at least one consistent UL LBT failure during the mobility operation; or 2) greater than a threshold number of UL LBT failures before detecting the mobility failure.
a successful mobility operation involving a source cell and a target cell (e.g., HO, PSCell addition, PSCell change), after experiencing greater than a threshold number of UL LBT failures during the mobility operation.
a radio-related failure in a serving cell (e.g., RLF in SpCell), after experiencing one of the following: 1) at least one consistent UL LBT failure in the serving cell; or 2) greater than a threshold number of LBT failures before detecting the radio-related failure.
a successful RA procedure in a serving cell (e.g., SpCell), after experiencing at least one consistent UL LBT failure in the serving cell.

In some embodiments, the threshold number of LBT failures may be configured by the RAN (e.g., via RRC). In some embodiments, each consistent UL LBT failure experienced by the UE (i.e., in connection with any of the above-listed events) was triggered and not cancelled in the UE MAC layer for a BWP of the (serving or target) cell.

In response to one of the above events, the UE can store information associated with RA procedures performed in one or multiple BWPs of a serving or target cell (e.g., PCell, PSCell, or SpCell). This information will be referred to as “random access information” (or RA information) in the following discussion. In various embodiments, the RA information can include one of the following:
RA information for a final RA procedure performed in a BWP of a serving, source, or target cell prior to the event (e.g., while T304 is running, prior to declaring HOF).
RA information for an initial RA procedure performed in a BWP of a serving, source, or target cell prior to the event (e.g., while T304 is running, prior to declaring HOF).
RA information for multiple RA procedures performed in respective BWPs of a serving, source, or target cell prior to the event (e.g., while T304 is running, prior to declaring HOF). Note that this arrangement may be used only if more than one consistent UL LBT failure is experienced prior to the event. This RA information may be arranged in various ways, such as: 1) multiple sets, each associated with a different BWP; 2) a list of multiple entries, each entry associated with a different BWP; or 3) grouping by parameter of the RA information.
   Certain variations of the above RA information may be employed for different events mentioned above. Some examples are given below for illustration.

In embodiments where the event is a failed or successful handover, the stored RA information may be for RA procedure(s) performed in a target PCell. In cases where the handover a DAPS handover and the UE experienced at least one consistent UL LBT failure in a source PCell, the stored RA information may be for RA procedure(s) performed in the source PCell.

In embodiments where the event is a successful mobility operation (e.g., handover, PSCell addition, PSCell change), the RA information can include indications of one or more of the following:
whether the UE experienced an LBT failure in any BWP during the successful mobility operation; and
whether the UE changed BWP (e.g., due to LBT issue) during the successful mobility operation.

In embodiments where the successful mobility operation is a successful handover and the UE generates SHR based on T304 elapsed time being above a configured threshold, the stored RA information is for RA procedures performed in respective BWPs of the serving cell while T304 is running until reaching the configured threshold.

In embodiments where the event is a radio-related failure in the serving cell (e.g., RLF in SpCell), the stored RA information may be for only the RA procedures that were triggered due to consistent UL LBT failure in another BWP of the serving cell. In some embodiments, the stored RA information may be for only the RA procedures since the last BWP switch in the serving cell. The last BWP switch may be due to a successful RA, an LBT parameter reconfiguration, an indication received via PDCCH for the serving cell, an RRC reconfiguration of firstActive UplinkBWP-Id for the serving cell, etc.

Subsequently, the UE can send to the RAN a message including the stored RA information. For example, the message can be a UEInformationResponse message transmitted in response to receiving a UEInformationRequest message from the RAN. The RA information can be included in one or more information elements (IEs) and/or fields of the message. The particular IEs and/or fields may depend on the particular event associated with the RA information, with some examples given below:
RLF-Report, when the event is a HOF due to LBT failures;
MCGFailureInformation, when the event is an MCG failure in DC due to LBT failures;
SCGFailureInformation, when the event is an SCG failure in DC due to LBT failures.
SuccessHO-Report (SHR), when the event is a successful handover after LBT failures;
SuccessPSCell-Report (or similar name), when the event is a successful PSCell change/addition after LBT failures;
RLF-Report, when the event is an RLF due to LBT failures;
RA-Report, when the event is a successful RA procedure after LBT failures;

In various embodiments, the RA information for RA procedures performed in a BWP of a source, target, or serving cell can include one or more of the following:
a BWP identity (ID);
an indication of whether the BWP was an initial BWP for the cell;
an indication of whether the BWP was a first active BWP for the cell;
an indication of whether the RA information was triggered by consistent LBT failure in another BWP of the cell;
an identity (ID) and/or a configuration of another BWP in the cell, in which a RA procedure was most recently performed before the RA procedure in the BWP;
time elapsed between initiating the RA procedure in the BWP and the most recent RA procedure in another BWP;
time elapsed between initiating the RA procedure in the BWP and the most recent BWP switch;
for each RA transmission (e.g., msg1/preamble, msg3, msgA) during the RA procedure, an indication of whether the transmission was blocked by LBT failure at lower layers;
time elapsed between consecutive RA transmissions during the RA procedure, such as between any of the following: consecutive msg3 transmissions, consecutive msg1 transmissions, consecutive msg3 transmissions, consecutive msgA transmissions, a msg3 transmission and a most recent msg1 transmission, or a msg3 transmission and a most recent msgA transmission (e.g., for fallback from two-step to four-step RA).
an LBT-specific configuration parameters for the BWP, such as a timer for consistent uplink LBT failure detection (lbt-FailureDetection Timer), a threshold number of LBT failures for declaring consistent UL LBT failure (lbt-FailureInstanceMaxCount), etc.

In some embodiments, the RA information in the message may also include a flag indicating that consistent UL LBT failure occurred in the source, target, or serving cell prior to the event. For example, the flag indicates that consistent UL LBT failures were triggered and not cancelled at MAC layer in one or more the BWPs of the cell at the time of declaring the radio-related failure (e.g., RLF) or at the time of successful completion of the mobility operation. In other embodiments, the RA information in the message may also include an indication of how many consistent UL LBT failures were triggered and not cancelled at MAC layer in the source, target, or serving cell at the time the event.

In some embodiments, the message may include RA information for both a source cell and a target cell for a mobility operation, e.g., for a DAPS HO from source cell in shared spectrum and target cell in shared spectrum. As an example, if RLF was experienced in the source PCell while performing a handover, the UE may include information on whether consistent UL LBT failures were triggered and not cancelled in the source PCell at the time of the RLF. In some embodiments, the RA information can include an indication of whether the RLF during handover was due to consistent UL LBT failures in all the BWPs of the source PCell.

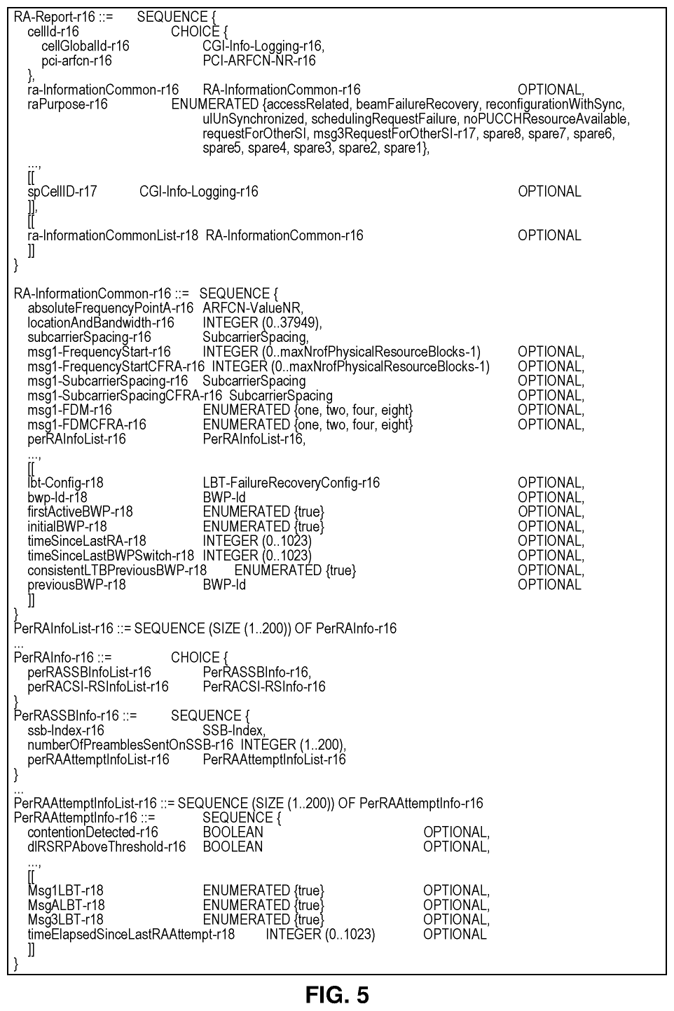

Certain embodiments can be realized as 3GPP specifications of message, information elements (IEs), and/or fields transmitted by a UE. FIG. 5 shows an exemplary ASN.1 data structure for an RRC RA-Report-r17 IE sent by a UE, according to some embodiments of the present disclosure. For example, this IE can be included in a UEInformationResponse message sent in response to a UEInformationRequest message from the RAN. This IE includes the following parameters or fields that relate to various embodiments described above:
RA-InformationCommon-r16, a data structure that includes various RA-related information, including:
   perRAInfoList-r16 which is a sequence of perRAInfo-r16 fields, each of which includes a perRASSBInfoList-r16 field;
   lbt-Config, which includes the LBT configuration for the LBT failure recovery in the BWP in which the random access procedure is performed;
   bwp-Id, which includes the BWP ID of the BWP in which the random access procedure is performed;
   firstActive-BWP, which indicates whether the BWP in which the RA procedure is performed was a BWP configured as first active BWP in the SpCell;
   initialBWP, which indicates whether the BWP in which the random access procedure is performed was an initial BWP in the SpCell;
   timeSinceLastRA, which indicates the time elapsed since the last random access procedure performed in the SpCell in a different BWP, while UL consistent LBT failures were triggered and not cancelled;
   imeSinceLastBWPSwitch, which indicates the time elapsed since the last BWP switch in the SpCell;
   consistentLBTPreviousBWP, which indicates whether consistent LBT failures where triggered in the BWP where random access was performed prior to the random access performed in this BWP;
   previousBWP, which indicates the ID of the BWP in which random access was performed prior to the random access performed in this BWP;
perRASSBInfoList-r16, which includes fields numberOfPreamblesSentOnSSB-r16 and perRAAttemptInfoList-r16, the latter of which is a sequence of perRAAttemptInfo-r16 fields;
perRAAttemptInfo-r16, which includes the following sub-fields that describe an individual RA attempt:
   contentionDected-r16, which indicates whether contention was detected for the RA attempt;
   dIRSRPAboveThreshold-r16, which indicates whether the observed DL RSRP for the RA attempt was above a threshold;
   msg1LBT-r18, which indicates whether an LBT failure was detected by the physical layer for the msg1 preamble transmission in the RA attempt;
   msg3LBT-r18, which indicates whether an LBT failure was detected by the physical layer for the msg3 transmission in the RA attempt;
   msg3LBT-r18, which indicates whether an LBT failure was detected by the physical layer for the msg3 transmission in the RA attempt; and
   timeElapsedSinceLastRAAttempt-r18, which indicates the time elapsed since the last RA attempt.

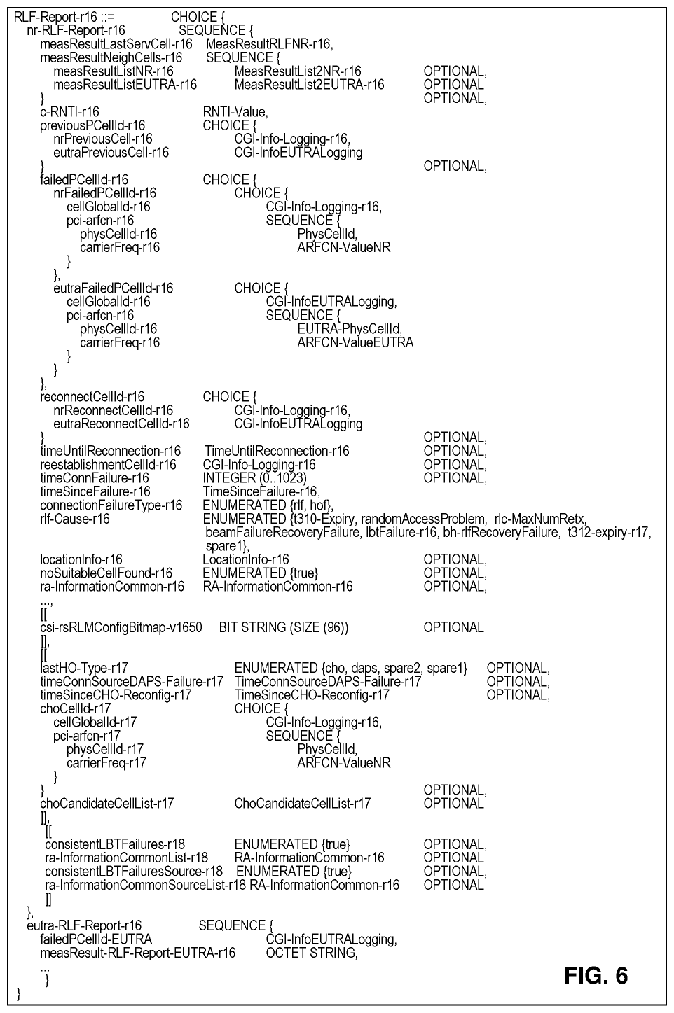

As another example, FIG. 6 shows an exemplary ASN.1 data structure for an RRC RLF-Report-r16 IE sent by a UE, according to some embodiments of the present disclosure. For example, this IE can be included in a UEInformationResponse message sent in response to a UEInformationRequest message from the RAN. This IE includes the following parameters or fields that relate to various embodiments described above:
ra-InformationCommonList-r16, which is an RA-InformationCommon-r16 data structure as described above, and includes that includes RA information associated with the RA procedures performed in the target PCell;
consistentLBTFailures-r18, which is an optional field whose presence indicates that consistent UL LBT failures were triggered and not cancelled in the target PCell at the time of the radio link failure or handover failure;
consistentLBTFailuresSource-r18, which is an optional field whose presence indicates that consistent UL LBT failures were triggered and not cancelled in the source PCell of the DAPS HO at the time of the radio link failure or handover failure; and
ra-InformationCommonSourceList-r18, which is an RA-InformationCommon-r16 data structure that includes the RA information associated with the RA procedures performed in the source PCell during the DAPS HO.

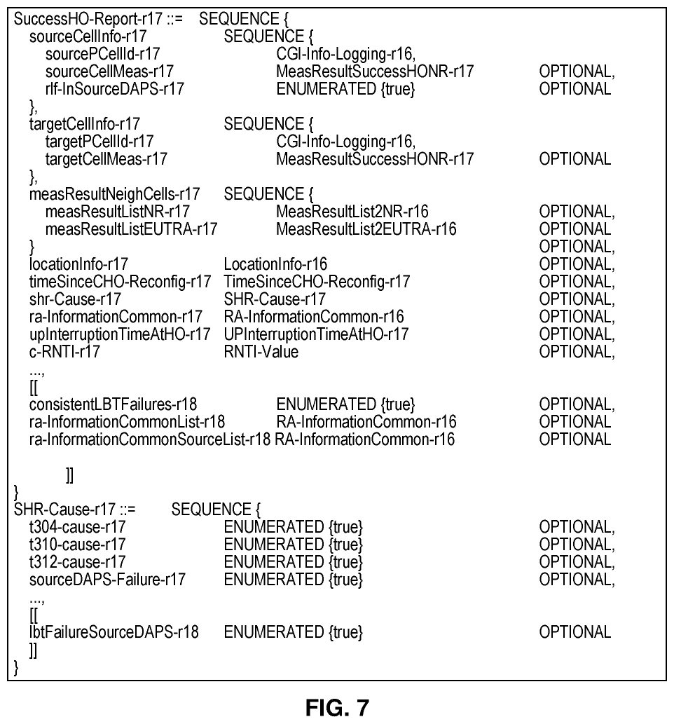

As another example, FIG. 7 shows an exemplary ASN.1 data structure for an RRC SuccessHO-Report-r17 IE sent by a UE, according to some embodiments of the present disclosure. For example, this IE can be included in a UEInformationResponse message sent in response to a UEInformationRequest message from the RAN. This IE includes the following parameters or fields that relate to various embodiments described above:
ra-InformationCommonList-r16, which is an RA-InformationCommon-r16 data structure as described above, and includes that includes RA information associated with the RA procedures performed in the target PCell;
consistentLBTFailures-r18, which is an optional field whose presence indicates that consistent UL LBT failures were triggered and not cancelled in the target PCell at the time of the radio link failure or handover failure;
ra-InformationCommonSourceList-r18, which is an RA-InformationCommon-r16 data structure that includes the RA information associated with the RA procedures performed in the source PCell during a DAPS HO;
SHR-Cause-r16, which includes various optional fields whose presence indicate respective causes of the SHR, including lbtFailureSourceDAPS, whose presence indicates that consistent the failure in the source PCell of the DAPS HO was due to LBT failures, i.e., consistent UL LBT failures in all the BWPs configured with PRACH resources of the source PCell.

Certain embodiments can be realized as procedural text in 3GPP specifications, which specify UE and/or RAN implementation. A first set of examples are given below for embodiments in which a UE stores random access information associated with multiple random access procedures in an RA-InformationCommon IE. As a first example in the first set, the following exemplary text for 3GPP TS 38.331 illustrates UE determination of RLF report content according to embodiments of the present disclosure. Note that certain existing portions of this section below have been omitted for conciseness.

### ***Begin Exemplary Text for 3GPP TS 38.331***

### 5.3.10.5 RLF Report Content Determination

The UE shall determine the content in the VarRLF-Report as follows:
   1> clear the information included in VarRLF-Report, if any;
   [unaffected portions have been omitted]
   1> if connectionFailureType is rlf and the rlf-Cause is set to randomAccessProblem or beamFailureRecoveryFailure or lbtFailure; or
   1> if connectionFailure Type is hof and if the failed handover is an intra-RAT handover:
      2> if consistent UL LBT failures were triggered and not cancelled at the time of the radio link failure or failed handover; or:
      2> if the number of LBT failures experienced in the PCell at the time of the radio link failure or handover failure is above a threshold:
         3> set consistentLBTFailure to true
         3> for each random access performed in different BWPs of the SpCell configured with PRACH resources, while consistent UL LBT failures were triggered and not cancelled at the time of the failure:
            4> set ra-InformationCommon to include the random-access related information as described in clause 5.7.10.5 in the ra-InformationCommonList;
      2> else if the random access procedure is only performed in one BWP:
         3> set the ra-InformationCommon to include the random-access related information as described in clause 5.7.10.5;
   1> if available, set the locationInfo as in 5.3.3.7.
The UE may discard the radio link failure information or handover failure information, i.e., release the UE variable VarRLF-Report, 48 hours after the radio link failure/handover failure is detected. NOTE 2: In this clause, the term ‘handover failure’ has been used to refer to ‘reconfiguration with sync failure’.

### ***End Exemplary Text for 3GPP TS 38.331***

As another example in the first set, the following exemplary text for 3GPP TS 38.331 illustrates UE determination of SHR content according to embodiments of the present disclosure. Note that certain existing portions of this section below have been omitted for conciseness.

### ***Begin Exemplary Text for 3GPP TS 38.331***

### 5.7.10.6 Actions for the Successful Handover Report Determination

The UE shall for the PCell:
   1> if the ratio between the value of the elapsed time of the timer T304 and the configured value of the timer T304, included in the last applied RRCReconfiguration message including the reconfigurationWithSync, is greater than thresholdPercentageT304 if included in the successHO-Config received before executing the last reconfiguration with sync; or
   1> if the ratio between the value of the elapsed time of the timer T310 and the configured value of the timer T310, configured while the UE was connected to the source PCell before executing the last reconfiguration with sync, is greater than thresholdPercentageT310 included in the successHO-Config if configured by the source PCell before executing the last reconfiguration with sync; or
   1> if the T312 associated to the measurement identity of the target cell was running at the time of initiating the execution of the reconfiguration with sync procedure and if the ratio between the value of the elapsed time of the timer T312 and the configured value of the timer T312, configured while the UE was connected to the source PCell before executing the last reconfiguration with sync, is greater than thresholdPercentageT312 included in the successHO-Config if configured by the source PCell before executing the last reconfiguration with sync; or
   1> if sourceDAPS-FailureReporting is included in the successHO-Config before executing the last reconfiguration with sync and is set to true and if the last executed handover was a DAPS handover and if an RLF occurred at the source PCell during the DAPS handover while T304 was running:
      2> store the successful handover information in VarSuccessHO-Report and determine the content in VarSuccessHO-Report as follows:
      [unaffected portions have been omitted]
         3> if the ratio between the value of the elapsed time of the timer T304 and the configured value of the T304 timer, included in the last applied RRCReconfiguration message including the reconfigurationWithSync, is greater than thresholdPercentageT304 if included in the successHO-Config received before executing the last reconfiguration with sync:
            4> set t304-cause in shr-Cause to true;
            4> if consistent UL LBT failures were triggered and not cancelled at the time of successfully executing the last reconfiguration with sync or if the number of LBT failures experienced while T304 was running is above a threshold and the random access was performed in more than one BWPs of the target PCell configured with PRACH resources:
            5> for each random access performed in different BWPs of the target PCell configured with PRACH resources while consistent UL LBT failures were triggered and not cancelled:
            6> set ra-InformationCommon to include the random-access related information associated to the target PCell as described in clause 5.7.10.5 in the ra-InformationCommonList;
      [unaffected portions have been omitted]
         3> if consistent UL LBT failures were experienced in all the BWPs of the source PCell configured with PRACH resources:
            4> set lbtFailureSourceDAPS to true;
         3> if consistent UL LBT failures were triggered and not cancelled at the time of failure in the source PCell or if the number of LBT failures experienced in the source PCell while T304 was running is above a threshold:
            4> set consistentLBTFailuresSource to true;
            4> set ra-InformationCommon to include the random-access related information as described associated to the target PCell in clause 5.7.10.5 in the ra-InformationCommonSourceList;
         3> if consistent UL LBT failures were triggered and not cancelled at the time of successfully executing the last reconfiguration with sync or if the number of LBT failures experienced in the target PCell while T304 was running is above a threshold and the random access was performed in more than one BWPs of the target PCell configured with PRACH resources; and
         3> if the ra-InformationCommon or ra-InformationCommonList is not set:
            4> set consistentLBTFailuresSource to true;
            4> for each random access performed in different BWPs of the target PCell configured with PRACH resources while consistent UL LBT failures were triggered and not cancelled:
            5> set ra-InformationCommon to include the random-access related information as described associated to the target PCell in clause 5.7.10.5 in the ra-InformationCommonList;
         3> else if random access was performed only in one BWP of the target PCell:
            4> set ra-InformationCommon to include the random-access related information as described in clause 5.7.10.5
               [unaffected portions have been omitted]
   1> release successHO-Config configured by the source PCell before executing the last reconfiguration with sync.
      The UE may discard the successful handover information, i.e., release the UE variable VarSuccessHO-Report, 48 hours after the last successful handover information is added to the VarSuccessHO-Report.

### ***End Exemplary Text for 3GPP TS 38.331***

As another example in the first set, the following exemplary text for 3GPP TS 38.331 illustrates UE actions upon successful completion of a random-access procedure or on completion of a request of on-demand system information according to embodiments of the present disclosure. Note that certain existing portions of this section below have been omitted for conciseness.

### ***Begin Exemplary Text for 3GPP TS 38.331***

5.7.10.4 Actions Upon Successful Completion of a Random-access Procedure or on Completion of a Request of On-demand System Information
Upon successfully performing random-access procedure initialized with 4-step or 2-step RA type, or upon failed or successfully completed on-demand system information acquisition procedure in RRC_IDLE or RRC_INACTIVE state, the UE shall:
   1> if the RPLMN or the PLMN selected by upper layers (see TS24.501 [23]) from the PLMN(s) included in the plmn-IdentityList in SIB1 is not included in plmn-IdentityList stored in a non-empty VarRA-Report:
      2> clear the information included in VarRA-Report;
   1> if the number of RA-Report entries stored in the ra-ReportList in VarRA-Report is less than maxRAReport:
      2> if the number of PLMN entries in plmn-IdentityList stored in VarRA-Report is less than maxPLMN; or
      2> if the number of PLMN entries in plmn-IdentityList stored in VarRA-Report is equal to maxPLMN and the list of EPLMNs is subset of or equal to the plmn-IdentityList stored in VarRA-Report:
         3> append the following contents associated to the successfully completed random-access procedure or the failed or successfully completed on-demand system information acquisition procedure as a new entry in the VarRA-Report:
         [unaffected portions have been omitted]
            4> if consistent UL LBT failures were triggered and not cancelled at the time of successfully completing the random-access procedure:
            5> for each random access performed in different BWPs of the target PCell configured with PRACH resources while consistent UL LBT failures were triggered and not cancelled:
            6> set the ra-InformationCommon in ra-InformationCommonList as specified in clause 5.7.10.5.
            4> else if random access was performed only in one BWP of the SpCell:
            5> set the ra-InformationCommon as specified in clause 5.7.10.5.
               The UE may discard the random access report information, i.e., release the UE variable VarRA-Report, 48 hours after the last successful random access procedure or the failed or successfully completed on-demand system information acquisition procedure related information is added to the VarRA-Report.
               NOTE 1: The UE does not log the RA information in the RA report if the triggering event of the random access is consistent UL LBT on SpCell as specified in TS 38.321 [6].

### ***End Exemplary Text for 3GPP TS 38.331***

A second set of examples are given below for embodiments in which a UE stores random access information for a single RA procedure in a RA-InformationCommon IE, even though with multiple random access procedures were triggered prior to a failure or successful handover completion. As a first example in the second set, the following exemplary text for 3GPP TS 38.331 illustrates UE determination of RLF report content according to embodiments of the present disclosure. Note that certain existing portions of this section below have been omitted for conciseness.

### ***Begin Exemplary Text for 3GPP TS 38.331***

### 5.3.10.5 RLF Report Content Determination

The UE shall determine the content in the VarRLF-Report as follows:
   1> clear the information included in VarRLF-Report, if any;
   [unaffected portions have been omitted]
   1> if connectionFailureType is rlf and the rlf-Cause is set to randomAccessProblem or beamFailureRecoveryFailure or lbtFailure; or
   1> if connectionFailure Type is hof and if the failed handover is an intra-RAT handover:
      2> set the ra-InformationCommon to include the random-access related information associated with the last random access procedure performed prior to the failure, as described in clause 5.7.10.5;
   1> if available, set the locationInfo as in 5.3.3.7.
      The UE may discard the radio link failure information or handover failure information, i.e., release the UE variable VarRLF-Report, 48 hours after the radio link failure/handover failure is detected. NOTE 2: In this clause, the term ‘handover failure’ has been used to refer to ‘reconfiguration with sync failure’.

### ***End Exemplary Text for 3GPP TS 38.331***

As another example in the second set, the following exemplary text for 3GPP TS 38.331 illustrates UE determination of SHR content according to embodiments of the present disclosure. Note that certain existing portions of this section below have been omitted for conciseness.

### ***Begin Exemplary Text for 3GPP TS 38.331***

### 5.7.10.6 Actions for the Successful Handover Report Determination

The UE shall for the PCell:
1> if the ratio between the value of the elapsed time of the timer T304 and the configured value of the timer T304, included in the last applied RRCReconfiguration message including the reconfigurationWithSync, is greater than thresholdPercentageT304 if included in the successHO-Config received before executing the last reconfiguration with sync; or
1> if the ratio between the value of the elapsed time of the timer T310 and the configured value of the timer T310, configured while the UE was connected to the source PCell before executing the last reconfiguration with sync, is greater than thresholdPercentageT310 included in the successHO-Config if configured by the source PCell before executing the last reconfiguration with sync; or
1> if the T312 associated to the measurement identity of the target cell was running at the time of initiating the execution of the reconfiguration with sync procedure and if the ratio between the value of the elapsed time of the timer T312 and the configured value of the timer T312, configured while the UE was connected to the source PCell before executing the last reconfiguration with sync, is greater than thresholdPercentageT312 included in the successHO-Config if configured by the source PCell before executing the last reconfiguration with sync; or
1> if sourceDAPS-FailureReporting is included in the successHO-Config before executing the last reconfiguration with sync and is set to true and if the last executed handover was a DAPS handover and if an RLF occurred at the source PCell during the DAPS handover while T304 was running:
   2> store the successful handover information in VarSuccessHO-Report and determine the content in Var SuccessHO-Report as follows:
   [unaffected portions have been omitted]
      3> if the ratio between the value of the elapsed time of the timer T304 and the configured value of the T304 timer, included in the last applied RRCReconfiguration message including the reconfigurationWithSync, is greater than thresholdPercentageT304 if included in the successHO-Config received before executing the last reconfiguration with sync:
         4> set t304-cause in shr-Cause to true;
         4> set the ra-InformationCommon to include the random-access related information associated to the last random access procedure in the target PCell, as specified in clause 5.7.10.5;
   [unaffected portions have been omitted]
      3> if sourceDAPS-FailureReporting included in the successHO-Config if configured by the source PCell before executing the last reconfiguration with sync is set to true, and if the last executed handover was a DAPS handover and if an RLF occurred at the source PCell during the DAPS handover while T304 was running:
         4> set sourceDAPS-Failure in shr-Cause to true;
         4> if consistent UL LBT failures were experienced in all the BWPs of the source PCell configured with PRACH resources:
         5> set lbtFailureSourceDAPS to true;
      3> if consistent UL LBT failures were triggered and not cancelled at the time of failure in the source PCell or if the number of LBT failures experienced in the source PCell while T304 was running is above a threshold:
         4> set consistentLBTFailuresSource to true;
         4> set ra-InformationCommon to include the random-access related information associated to the last random access procedure performed in the source PCell;
      3> if consistent UL LBT failures were triggered and not cancelled at the time of successfully executing the last reconfiguration with sync or if the number of LBT failures experienced in the target PCell while T304 was running is above a threshold:
         4> set ra-InformationCommon to include the random-access related information associated to the last random access procedure performed in the target PCell, as described in clause 5.7.10.5;
[unaffected portions have been omitted]
1> release successHO-Config configured by the source PCell before executing the last reconfiguration with sync.
   The UE may discard the successful handover information, i.e., release the UE variable VarSuccessHO-Report, 48 hours after the last successful handover information is added to the VarSuccessHO-Report.

### ***End Exemplary Text for 3GPP TS 38.331***

As another example in the second set, the following exemplary text for 3GPP TS 38.331 illustrates UE actions upon successful completion of a random-access procedure or on completion of a request of on-demand system information according to embodiments of the present disclosure. Note that certain existing portions of this section below have been omitted for conciseness.

### ***Begin Exemplary Text for 3GPP TS 38.331

5.7.10.4 Actions upon successful completion of a random-access procedure or on completion of a request of on-demand system information

Upon successfully performing random-access procedure initialized with 4-step or 2-step RA type, or upon failed or successfully completed on-demand system information acquisition procedure in RRC_IDLE or RRC_INACTIVE state, the UE shall:
1> if the RPLMN or the PLMN selected by upper layers (see TS24.501 [23]) from the PLMN(s) included in the plmn-IdentityList in SIBI is not included in plmn-IdentityList stored in a non-empty VarRA-Report:
   2> clear the information included in VarRA-Report;
1> if the number of RA-Report entries stored in the ra-ReportList in VarRA-Report is less than maxRAReport:
   2> if the number of PLMN entries in plmn-IdentityList stored in VarRA-Report is less than maxPLMN; or
   2> if the number of PLMN entries in plmn-IdentityList stored in VarRA-Report is equal to maxPLMN and the list of EPLMNs is subset of or equal to the plmn-IdentityList stored in VarRA-Report:
      3> append the following contents associated to the successfully completed random-access procedure or the failed or successfully completed on-demand system information acquisition procedure as a new entry in the VarRA-Report:
      [unaffected portions have been omitted]
         4> set the ra-InformationCommon associated to the last successfully performed random access procedure as specified in clause 5.7.10.5.
            The UE may discard the random access report information, i.e., release the UE variable VarRA-Report, 48 hours after the last successful random access procedure or the failed or successfully completed on-demand system information acquisition procedure related information is added to the VarRA-Report.
            NOTE 1: The UE does not log the RA information in the RA report if the triggering event of the random access is consistent UL LBT on SpCell as specified in TS 38.321 [6].

### ***End Exemplary Text for 3GPP TS 38.331***

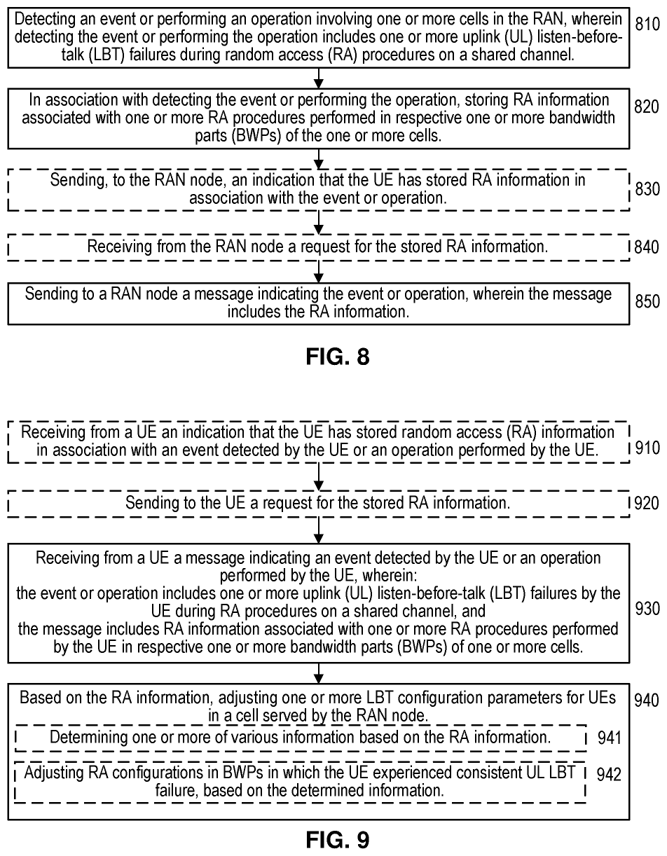

Various features of the embodiments described above correspond to various operations illustrated in FIGS. 8-9, which show exemplary methods (e.g., procedures) for a UE and a RAN node, respectively. In other words, various features of the operations described below correspond to various embodiments described above. Furthermore, the exemplary methods shown in FIGS. 8-9 can be used cooperatively to provide various benefits, advantages, and/or solutions to problems described herein. Although FIGS. 8-9 show specific blocks in particular orders, the operations of the exemplary methods can be performed in different orders than shown and can be combined and/or divided into blocks having different functionality than shown. Optional blocks or operations are indicated by dashed lines.

In particular, FIG. 8 shows an exemplary method (e.g., procedure) for a UE configured to operate in unlicensed spectrum in a radio access network (RAN), according to various embodiments of the present disclosure. The exemplary method can be performed by a UE (e.g., wireless device) such as described elsewhere herein.

The exemplary method can include the operations of block 810, where the UE can detect an event or perform an operation involving one or more cells in the RAN, where detecting the event or performing the operation includes one or more UL LBT failures during RA procedures on a shared channel. The exemplary method can also include the operations of block 820, where in association with detecting the event or performing the operation, the UE can store RA information associated with one or more RA procedures performed in respective one or more BWPs of the one or more cells. The exemplary method can also include the operations of block 850, where the UE can subsequently send to a RAN node a message indicating the event or operation, where the message includes the RA information.

In some embodiments, the event or operation is a failed mobility operation from a source cell to a target cell and the one or more UL LBT failures include one of the following: at least one consistent UL LBT failure in a BWP of the target cell, or more than a threshold number of UL LBT failures in the target cell during the failed mobility operation. In such case, the RA information is associated with one or more RA procedures performed in respective one or more BWPs of the target cell.

In some of these embodiments, the failed mobility operation is a dual-active protocol stack (DAPS) handover and the one or more UL LBT failures also include one of the following: at least one consistent UL LBT failure in a BWP of the source cell, or more than a threshold number of UL LBT failures in the source cell during the failed mobility operation. In such cases, the RA information is also associated with one or more RA procedures performed in respective one or more BWPs of the source cell.

In other embodiments, the event or operation is a radio-related failure in a serving cell and the one or more UL LBT failures include one of the following: at least one consistent UL LBT failure in a BWP of the serving cell, or more than a threshold number of UL LBT failures in the serving cell during the radio-related failure. In such cases, the RA information is associated with one or more RA procedures performed in respective one or more BWPs of the serving cell.

In other embodiments, the event or operation is a radio link failure (RLF) in a serving cell and the RA information is associated with a last one of multiple RA procedures the UE performed in one of the BWPs of the serving cell to recover from the RLF.

In various ones of these embodiments, the message is a UEInformationResponse message and the RA information is included a radio link failure (RLF) report information element of the message. FIG. 6 shows an example of these embodiments.

In other embodiments, the event or operation is a successful mobility operation from a source cell to a target cell and the one or more UL LBT failures include more than a threshold number of UL LBT failures in the target cell during the successful mobility operation. In such case, the RA information is associated with one or more RA procedures performed in respective one or more BWPs of the target cell.

In other embodiments, the event or operation is a successful mobility operation from a source cell to a target cell and the RA information is associated with a last one of multiple RA procedures the UE performed in one of the BWPs of the target cell.

In some of these embodiments, the successful mobility operation is a DAPS handover and the one or more UL LBT failures also include one of the following: at least one consistent UL LBT failure in a BWP of the target cell, or more than a threshold number of UL LBT failures in the source cell during the successful mobility operation. In such cases, the RA information is also associated with one or more RA procedures performed in respective one or more BWPs of the source cell.

In various ones of these embodiments, the message is a UEInformationResponse message and the RA information is included a successful handover report (SHR) information element of the message. FIG. 7 shows an example of these embodiments.

In other embodiments, the event or operation is a successful RA procedure in a serving cell and the one or more UL LBT failures include at least one consistent UL LBT failure in a BWP of the serving cell before the successful RA procedure. In such cases, the RA information is associated with one or more RA procedures performed in respective one or more BWPs of the serving cell. In some of these embodiments, the message is a UEInformationResponse message and the RA information is included a RA report information element of the message. FIG. 5 shows an example of these embodiments.

In various embodiments, the RA information can include one of the following:
RA information for an initial RA procedure performed in a cell before detecting the event or during the operation;
RA information for a final RA procedure performed in a cell before detecting the event or during the operation;
RA information for only RA procedures performed a cell due to consistent UL LBT failure in another BWP of the cell;
RA information for only RA procedures performed a cell since a most recent BWP switch in the cell; or
RA information for a plurality of RA procedures performed in a respective plurality of BWPs of a cell before detecting the event or during the operation.

In various embodiments, the RA information for each RA procedure includes one or more of the following information:
an identity of a BWP in which the RA procedure was performed;
an indication of whether the BWP was an initial BWP for the cell;
an indication of whether the BWP was a first active BWP for the cell;
an indication of whether the RA information was triggered by consistent LBT failure in another BWP of the cell;
an identity and/or a configuration of another BWP in the cell, in which a RA procedure was most recently performed before the RA procedure in the BWP;
time elapsed between the most recent RA procedure in another BWP and initiating the RA procedure in the BWP and;
time elapsed between the most recent BWP switch and initiating the RA procedure in the BWP;
for each RA transmission during the RA procedure, an indication of whether the transmission was blocked by LBT failure at lower layers;
time elapsed between different RA transmissions during the RA procedure; and
one or more LBT-specific configuration parameters for the BWP.

In some of these embodiments, the RA information can also include one or more of the following:
an indication that consistent UL LBT failure occurred in the one or more cells before detecting the event or during the operation; and
a number of consistent UL LBT failures that were triggered and not cancelled at MAC layer in the one or more cells before detecting the event or during the operation.

In some of these embodiments, the time elapsed between different transmissions during the RA procedure (e.g., as indicated in the RA information) include time elapsed between one or more of the following: consecutive msg1 transmissions, consecutive msg3 transmissions, consecutive msgA transmissions, a msg3 transmission and a most recent msg1 transmission, and a msg3 transmission and a most recent msgA transmission.

In some embodiments, the exemplary method can also include the operations of blocks 830-840, where the UE can send to the RAN node an indication that the UE has stored RA information in association with the event or operation and receive from the RAN node a request for the stored RA information. The message is sent in block 850 in response to the request.

In addition, FIG. 9 shows an exemplary method (e.g., procedure) for a RAN node configured to serve UEs via a cell in unlicensed spectrum, according to various embodiments of the present disclosure. The exemplary method can be performed by a RAN node (e.g., base station, eNB, gNB, ng-eNB, etc.) such as described elsewhere herein.

The exemplary method can include the operations of block 930, where the RAN node can receive from a UE a message indicating an event detected by the UE or an operation performed by the UE. The event or operation includes one or more UL LBT failures by the UE during random access (RA) procedures on a shared channel. The message includes RA information associated with one or more RA procedures performed by the UE in respective one or more bandwidth parts (BWPs) of one or more cells. The exemplary method can also include the operations of block 940, where based on the RA information, the RAN node can adjust one or more LBT configuration parameters for UEs in a cell served by the RAN node.

In some embodiments, the event or operation is a failed mobility operation from a source cell to a target cell and the one or more UL LBT failures include one of the following: at least one consistent UL LBT failure in a BWP of the target cell, or more than a threshold number of UL LBT failures in the target cell during the failed mobility operation. In such case, the RA information is associated with one or more RA procedures performed in respective one or more BWPs of the target cell.

In some of these embodiments, the failed mobility operation is a dual-active protocol stack (DAPS) handover and the one or more UL LBT failures also include one of the following: at least one consistent UL LBT failure in a BWP of the source cell, or more than a threshold number of UL LBT failures in the source cell during the failed mobility operation. In such cases, the RA information is also associated with one or more RA procedures performed in respective one or more BWPs of the source cell.

In other embodiments, the event or operation is a radio-related failure in a serving cell and the one or more UL LBT failures include one of the following: at least one consistent UL LBT failure in a BWP of the serving cell, or more than a threshold number of UL LBT failures in the serving cell during the radio-related failure. In such cases, the RA information is associated with one or more RA procedures performed in respective one or more BWPs of the serving cell.

In other embodiments, the event or operation is a radio link failure (RLF) in a serving cell and the RA information is associated with a last one of multiple RA procedures the UE performed in one of the BWPs of the serving cell to recover from the RLF.

In various ones of these embodiments, the message is a UEInformationResponse message and the RA information is included in an RLF report information element of the message. FIG. 6 shows an example of these embodiments.

In other embodiments, the event or operation is a successful mobility operation from a source cell to a target cell and the one or more UL LBT failures include more than a threshold number of UL LBT failures in the target cell during the successful mobility operation. In such case, the RA information is associated with one or more RA procedures performed in respective one or more BWPs of the target cell.

In other embodiments, the event or operation is a successful mobility operation from a source cell to a target cell and the RA information is associated with a last one of multiple RA procedures the UE performed in one of the BWPs of the target cell.

In some of these embodiments, the successful mobility operation is a DAPS handover and the one or more UL LBT failures also include one of the following: at least one consistent UL LBT failure in a BWP of the target cell, or more than a threshold number of UL LBT failures in the source cell during the successful mobility operation. In such cases, the RA information is also associated with one or more RA procedures performed in respective one or more BWPs of the source cell.

In various ones of these embodiments, the message is a UEInformationResponse message and the RA information is included a successful handover report (SHR) information element of the message. FIG. 7 shows an example of these embodiments.

In other embodiments, the event or operation is a successful RA procedure in a serving cell and the one or more UL LBT failures include at least one consistent UL LBT failure in a BWP of the serving cell before the successful RA procedure. In such cases, the RA information is associated with one or more RA procedures performed in respective one or more BWPs of the serving cell. In some of these embodiments, the message is a UEInformationResponse message and the RA information is included a RA report information element of the message. FIG. 5 shows an example of these embodiments.

In various embodiments, the RA information can include any of the same information described above for UE embodiments illustrated by FIG. 8.

In some embodiments, the exemplary method can also include the operations of blocks 910-920, where the RAN node can receive from the UE an indication that the UE has stored RA information in association with the event or operation and send to the UE a request for the stored RA information. The message is received in block 930 in response to the request.

In some embodiments, adjusting one or more LBT configuration parameters for UEs based on the RA information in block 940 can include the following operations, labelled with corresponding sub-block numbers:
(941) determining one or more of the following information based on the RA information:
   BWPs in which the UE experienced consistent UL LBT failure;
   how many BWP switches were performed by the UE due to consistent UL LBT failures;
   one or more types of UE RA transmissions that resulted in UL LBT failures;
   which portion of the UE's reported LBT failures occurred during RA procedures in the shared channel; and
(942) adjusting RA configurations in BWPs in which the UE experienced consistent UL LBT failure, based on the determined information.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

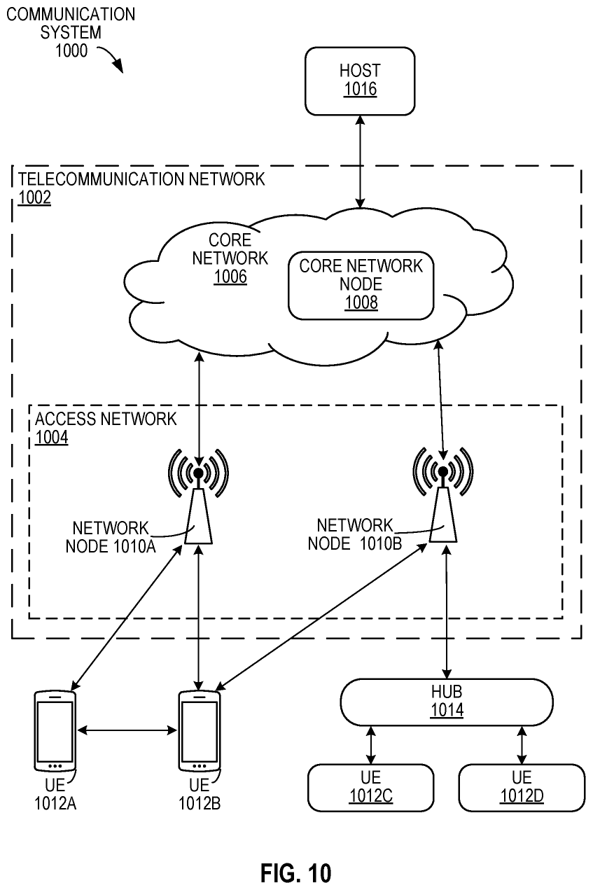

FIG. 10 shows an example of a communication system 1000 in accordance with some embodiments. In this example, communication system 1000 includes a telecommunication network 1002 that includes an access network 1004 (e.g., RAN) and a core network 1006, which includes one or more core network nodes 1008. Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to access network 1004 on a predetermined schedule, when triggered by an internal or external event, or in response to requests from access network 1004. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1014 communicates with access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs. Commands or instructions may be received from the UEs, network nodes 1010, or by executable code, script, process, or other instructions in hub 1014. As another example, hub 1014 may be a data collector that acts as temporary storage for UE data and, in some embodiments, may perform analysis or other processing of the data. As another example, hub 1014 may be a content source. For example, for a UE that is a VR headset, display, loudspeaker or other media delivery device, hub 1014 may retrieve VR assets, video, audio, or other media or data related to sensory information via a network node, which hub 1014 then provides to the UE either directly, after performing local processing, and/or after adding additional local content. In still another example, hub 1014 acts as a proxy server or orchestrator for the UEs, in particular in if one or more of the UEs are low energy IoT devices.

Hub 1014 may have a constant/persistent or intermittent connection to network node 1010b. Hub 1014 may also allow for a different communication scheme and/or schedule between hub 1014 and UEs (e.g., UE 1012c and/or 1012d), and between hub 1014 and core network 1006. In other examples, hub 1014 is connected to core network 1006 and/or one or more UEs via a wired connection. Moreover, hub 1014 may be configured to connect to an M2M service provider over access network 1004 and/or to another UE over a direct connection. In some scenarios, UEs may establish a wireless connection with network nodes 1010 while still connected via hub 1014 via a wired or wireless connection. In some embodiments, hub 1014 may be a dedicated hub—that is, a hub whose primary function is to route communications to/from the UEs from/to network node 1010b. In other embodiments, hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1100 includes processing circuitry 1102 that is operatively coupled via bus 1104 to input/output interface 1106, power source 1108, memory 1110, communication interface 1112, and possibly other components not explicitly shown. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

Processing circuitry 1102 is configured to process instructions and data and may be configured to implement any sequential state machine operative to execute instructions stored as machine-readable computer programs in memory 1110. Processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1102 may include multiple central processing units (CPUs).

In the example, input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1108 is structured as a battery or battery pack. Other types of power sources, such as an external power source (e.g., an electricity outlet), photovoltaic device, or power cell, may be used. Power source 1108 may further include power circuitry for delivering power from power source 1108 itself, and/or an external power source, to the various parts of UE 1100 via input circuitry or an interface such as an electrical power cable. Delivering power may be, for example, for charging power source 1108. Power circuitry may perform any formatting, converting, or other modification to the power from power source 1108 to make the power suitable for the respective components of UE 1100 to which power is supplied.

Memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1110 includes one or more application programs 1114, such as an operating system, web browser application, a widget, gadget engine, or other application, and corresponding data 1116. Memory 1110 may store, for use by UE 1100, any of a variety of various operating systems or combinations of operating systems.

Memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1110 may allow UE 1100 to access instructions, application programs and the like, stored on transitory or non-transitory memory media, to off-load data, or to upload data. An article of manufacture, such as one utilizing a communication system may be tangibly embodied as or in memory 1110, which may be or comprise a device-readable storage medium.

Processing circuitry 1102 may be configured to communicate with an access network or other network using communication interface 1112. Communication interface 1112 may comprise one or more communication subsystems and may include or be communicatively coupled to an antenna 1122. Communication interface 1112 may include one or more transceivers used to communicate, such as by communicating with one or more remote transceivers of another device capable of wireless communication (e.g., another UE or a network node in an access network). Each transceiver may include transmitter 1118 and/or receiver 1120 appropriate to provide network communications (e.g., optical, electrical, frequency allocations, and so forth). Moreover, transmitter 1118 and/or receiver 1120 may be coupled to one or more antennas (e.g., antenna 1122) and may share circuit components, software, or firmware, or alternatively be implemented separately.

In the illustrated embodiment, communication functions of communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

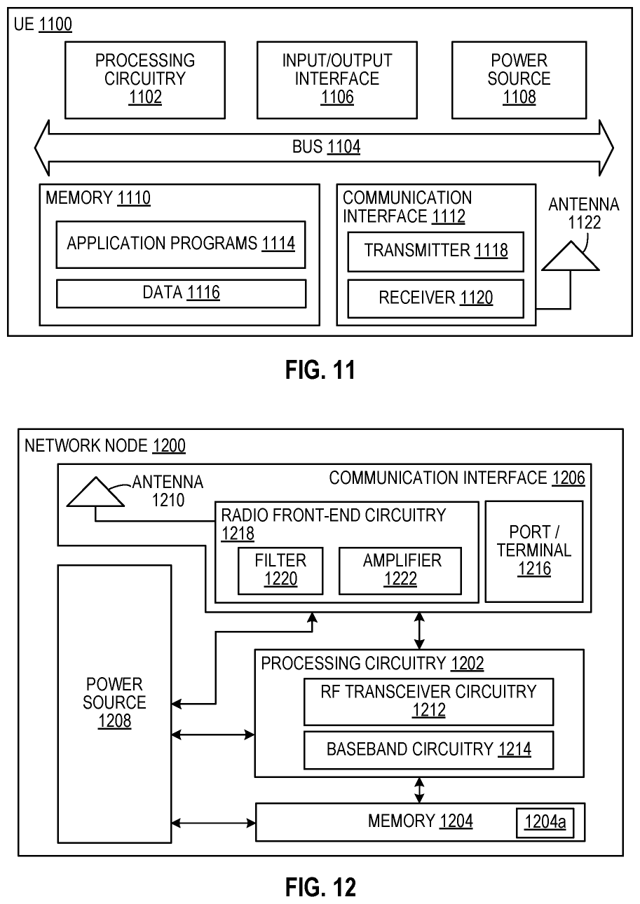

FIG. 12 shows a network node 1200 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1200 includes processing circuitry 1202, memory 1204, communication interface 1206, and power source 1208. Network node 1200 may be composed of multiple physically separate components (e.g., a NodeB component and a RNC component, or a BTS component and a BSC component, etc.), which may each have their own respective components. In certain scenarios in which network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). Network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

Processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as memory 1204, to provide network node 1200 functionality.

In some embodiments, processing circuitry 1202 includes a system on a chip (SOC). In some embodiments, processing circuitry 1202 includes radio frequency (RF) transceiver circuitry 1212 and/or baseband processing circuitry 1214. In some embodiments, RF transceiver circuitry 1212 and baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

Memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1202. Memory 1204 may store any suitable instructions, data, or information, including a computer program, software, an application including one or more of logic, rules, code, tables, and/or other instructions (collectively denoted computer program product 1204a) capable of being executed by processing circuitry 1202 and utilized by network node 1200. Memory 1204 may be used to store any calculations made by processing circuitry 1202 and/or any data received via communication interface 1206. In some embodiments, processing circuitry 1202 and memory 1204 is integrated.

Communication interface 1206 is used in wired or wireless communication of signaling and/or data between a network node, access network, and/or UE. As illustrated, communication interface 1206 comprises port(s)/terminal(s) 1216 to send and receive data, for example to and from a network over a wired connection. Communication interface 1206 also includes radio front-end circuitry 1218 that may be coupled to, or in certain embodiments a part of, antenna 1210. Radio front-end circuitry 1218 comprises filters 1220 and amplifiers 1222. Radio front-end circuitry 1218 may be connected to an antenna 1210 and processing circuitry 1202. Radio front-end circuitry 1218 may be configured to condition signals communicated between antenna 1210 and processing circuitry 1202. Radio front-end circuitry 1218 may receive digital data that is to be sent out to other network nodes or UEs via a wireless connection. Radio front-end circuitry 1218 may convert the digital data into a radio signal having the appropriate channel and bandwidth parameters using a combination of filters 1220 and/or amplifiers 1222. The radio signal may then be transmitted via antenna 1210. Similarly, when receiving data, antenna 1210 may collect radio signals which are then converted into digital data by radio front-end circuitry 1218. The digital data may be passed to processing circuitry 1202. In other embodiments, the communication interface may comprise different components and/or different combinations of components.

In certain alternative embodiments, network node 1200 does not include separate radio front-end circuitry 1218, instead, processing circuitry 1202 includes radio front-end circuitry and is connected to antenna 1210. Similarly, in some embodiments, all or some of RF transceiver circuitry 1212 is part of communication interface 1206. In still other embodiments, communication interface 1206 includes one or more ports or terminals 1216, radio front-end circuitry 1218, and RF transceiver circuitry 1212, as part of a radio unit (not shown), and communication interface 1206 communicates with baseband processing circuitry 1214, which is part of a digital unit (not shown).

Antenna 1210 may include one or more antennas, or antenna arrays, configured to send and/or receive wireless signals. Antenna 1210 may be coupled to radio front-end circuitry 1218 and may be any type of antenna capable of transmitting and receiving data and/or signals wirelessly. In certain embodiments, antenna 1210 is separate from network node 1200 and connectable to network node 1200 through an interface or port.

Antenna 1210, communication interface 1206, and/or processing circuitry 1202 may be configured to perform any receiving operations and/or certain obtaining operations described herein as being performed by the network node. Any information, data and/or signals may be received from a UE, another network node and/or any other network equipment. Similarly, antenna 1210, communication interface 1206, and/or processing circuitry 1202 may be configured to perform any transmitting operations described herein as being performed by the network node. Any information, data and/or signals may be transmitted to a UE, another network node and/or any other network equipment.

Power source 1208 provides power to the various components of network node 1200 in a form suitable for the respective components (e.g., at a voltage and current level needed for each respective component). Power source 1208 may further comprise, or be coupled to, power management circuitry to supply the components of network node 1200 with power for performing the functionality described herein. For example, network node 1200 may be connectable to an external power source (e.g., the power grid, an electricity outlet) via an input circuitry or interface such as an electrical cable, whereby the external power source supplies power to power circuitry of power source 1208. As a further example, power source 1208 may comprise a source of power in the form of a battery or battery pack which is connected to, or integrated in, power circuitry. The battery may provide backup power should the external power source fail.

Embodiments of network node 1200 may include additional components beyond those shown in FIG. 12 for providing certain aspects of the network node's functionality, including any of the functionality described herein and/or any functionality necessary to support the subject matter described herein. For example, network node 1200 may include user interface equipment to allow input of information into network node 1200 and to allow output of information from network node 1200. This may allow a user to perform diagnostic, maintenance, repair, and other administrative functions for network node 1200.

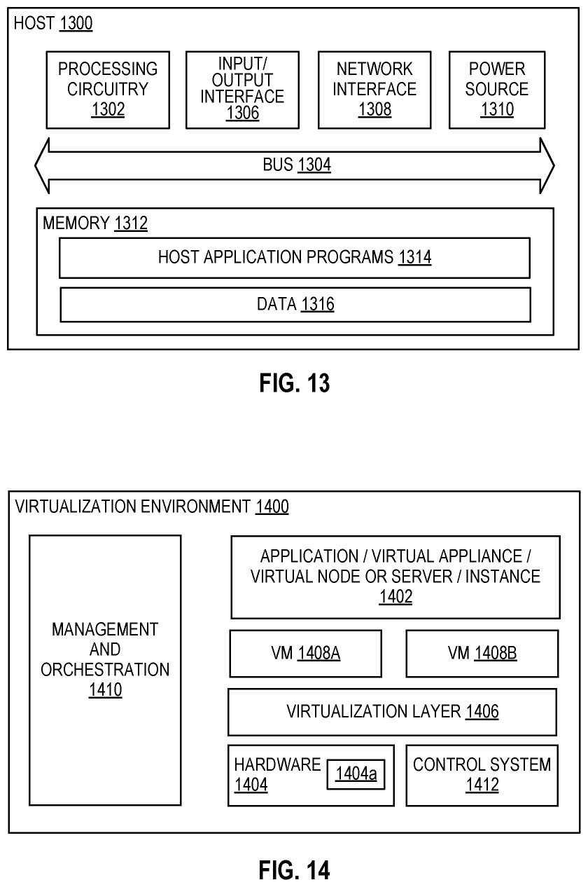

FIG. 13 is a block diagram of a host 1300, which may be an embodiment of host 1016 of FIG. 10, in accordance with various aspects described herein. As used herein, a host may be or comprise various combinations hardware and/or software, including a standalone server, a blade server, a cloud-implemented server, a distributed server, a virtual machine, container, or processing resources in a server farm. Host 1300 may provide one or more services to one or more UEs.

Host 1300 includes processing circuitry 1302 that is operatively coupled via a bus 1304 to input/output interface 1306, network interface 1308, power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

Memory 1312 may include one or more computer programs including one or more host application programs 1314 and data 1316, which may include user data, e.g., data generated by a UE for host 1300 or data generated by host 1300 for a UE. Embodiments of host 1300 may utilize only a subset or all of the components shown. Host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1314 may also provide for user authentication and licensing checks and may periodically report health, routes, and content availability to a central node, such as a device in or on the edge of a core network. Accordingly, host 1300 may select and/or indicate a different host for over-the-top services for a UE. Host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc. FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in virtualization environment 1400 to implement some of the features, functions, and/or benefits of some of the embodiments disclosed herein.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a-b (one or more of which may be generally referred to as VMs 1408), and/or perform any of the functions, features and/or benefits described in relation with some embodiments described herein. Virtualization layer 1406 may present a virtual operating platform that appears like networking hardware to VMs 1408.

VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1408 may be a software implementation of a physical machine that runs programs as if they were executing on a physical, non-virtualized machine. Each VM 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of hardware 1404 and corresponds to application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

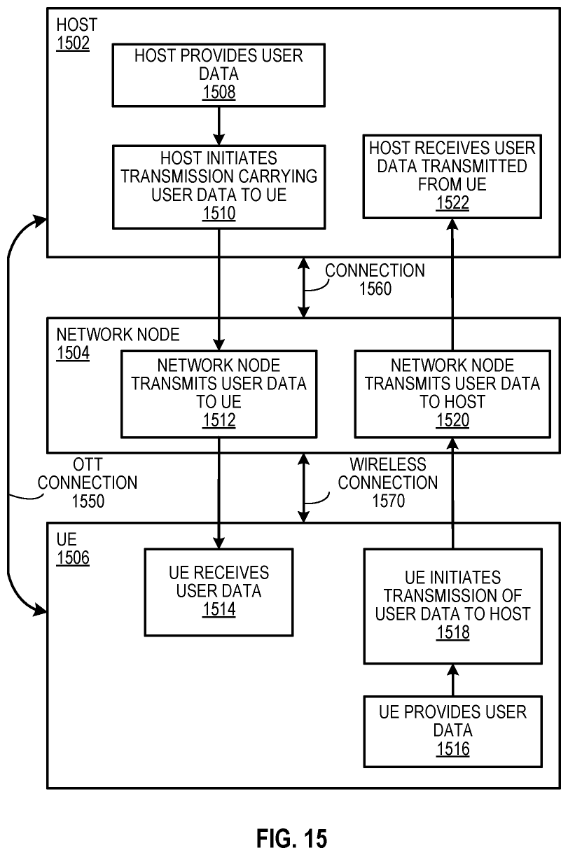

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. Host 1502 also includes software, which is stored in or accessible by host 1502 and executable by the processing circuitry. The software includes a host application that may be operable to provide a service to a remote user, such as UE 1506 connecting via an over-the-top (OTT) connection 1550 extending between UE 1506 and host 1502. In providing the service to the remote user, a host application may provide user data which is transmitted using OTT connection 1550.

Network node 1504 includes hardware enabling it to communicate with host 1502 and UE 1506. Connection 1560 may be direct or pass through a core network (like core network 1006 of FIG. 10) and/or one or more other intermediate networks, such as one or more public, private, or hosted networks. For example, an intermediate network may be a backbone network or the Internet.

UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of host 1502. In host 1502, an executing host application may communicate with the executing client application via OTT connection 1550 terminating at UE 1506 and host 1502. In providing the service to the user, the UE's client application may receive request data from the host's host application and provide user data in response to the request data. OTT connection 1550 may transfer both the request data and the user data. The UE's client application may interact with the user to generate the user data that it provides to the host application through OTT connection 1550.

OTT connection 1550 may extend via a connection 1560 between host 1502 and network node 1504 and via a wireless connection 1570 between network node 1504 and UE 1506 to provide the connection between host 1502 and UE 1506. Connection 1560 and wireless connection 1570, over which OTT connection 1550 may be provided, have been drawn abstractly to illustrate the communication between host 1502 and UE 1506 via network node 1504, without explicit reference to any intermediary devices and the precise routing of messages via these devices.

As an example of transmitting data via OTT connection 1550, in step 1508, host 1502 provides user data, which may be performed by executing a host application. In some embodiments, the user data is associated with a particular human user interacting with UE 1506. In other embodiments, the user data is associated with a UE 1506 that shares data with host 1502 without explicit human interaction. In step 1510, host 1502 initiates a transmission carrying the user data towards UE 1506. Host 1502 may initiate the transmission responsive to a request transmitted by UE 1506. The request may be caused by human interaction with UE 1506 or by operation of the client application executing on UE 1506. The transmission may pass via network node 1504, in accordance with the teachings of the embodiments described throughout this disclosure. Accordingly, in step 1512, network node 1504 transmits to UE 1506 the user data that was carried in the transmission that host 1502 initiated, in accordance with the teachings of the embodiments described throughout this disclosure. In step 1514, UE 1506 receives the user data carried in the transmission, which may be performed by a client application executed on UE 1506 associated with the host application executed by host 1502.

In some examples, UE 1506 executes a client application which provides user data to host 1502. The user data may be provided in reaction or response to the data received from host 1502. Accordingly, in step 1516, UE 1506 may provide user data, which may be performed by executing the client application. In providing the user data, the client application may further consider user input received from the user via an input/output interface of UE 1506. Regardless of the specific manner in which the user data was provided, UE 1506 initiates, in step 1518, transmission of the user data towards host 1502 via network node 1504. In step 1520, in accordance with the teachings of the embodiments described throughout this disclosure, network node 1504 receives user data from UE 1506 and initiates transmission of the received user data towards host 1502. In step 1522, host 1502 receives the user data carried in the transmission initiated by UE 1506.

One or more of the various embodiments improve the performance of OTT services provided to UE 1506 using OTT connection 1550, in which wireless connection 1570 forms the last segment. More precisely, embodiments may improve operation of UEs and RAN nodes in unlicensed spectrum. For example, based on RA information logged by a UE, the RAN can determine how many BWP switches due to consistent UL LBT failures a UE made before detecting the event or during performing the operation. Since UL LBT failures may have occurred in the RA procedure itself, the RAN can adjust and/or optimize RA performance in the respective BWPs in which the UE attempted RA. Based on the RA information, the RAN may also determine a specific RA transmission subject to UL LBT failures. In some embodiments, the RAN can also determine the respective portions of the UE's UL LBT failures that occurred in RA and in UL transmissions for other channels. In this manner, the RAN can adjust and/or optimize UL LBT and/or RA settings for UEs operating in the cell based on the RA information reported by UEs. These improvements can lead to better utilization of shared spectrum for delivering OTT services to end users, which increases the value of such services to end users and service providers.

In an example scenario, factory status information may be collected and analyzed by host 1502. As another example, host 1502 may process audio and video data which may have been retrieved from a UE for use in creating maps. As another example, host 1502 may collect and analyze real-time data to assist in controlling vehicle congestion (e.g., controlling traffic lights). As another example, host 1502 may store surveillance video uploaded by a UE. As another example, host 1502 may store or control access to media content such as video, audio, VR or AR which it can broadcast, multicast or unicast to UEs. As other examples, host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 1550 between host 1502 and UE 1506, in response to variations in the measurement results. The measurement procedure and/or the network functionality for reconfiguring the OTT connection may be implemented in software and hardware of host 1502 and/or UE 1506. In some embodiments, sensors (not shown) may be deployed in or in association with other devices through which OTT connection 1550 passes; the sensors may participate in the measurement procedure by supplying values of the monitored quantities exemplified above, or supplying values of other physical quantities from which software may compute or estimate the monitored quantities. Reconfiguring OTT connection 1550 may include changing message format, retransmission settings, preferred routing etc.; reconfiguring need not directly alter operation of network node 1504. Such procedures and functionalities may be known and practiced in the art. In certain embodiments, measurements may involve proprietary UE signaling that facilitates measurements of throughput, propagation times, latency and the like, by host 1502. The measurements may be implemented in that software causes messages to be transmitted, in particular empty or ‘dummy’ messages, using OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured to operate in unlicensed spectrum in a radio access network (RAN), the method comprising:
   detecting an event or performing an operation involving one or more cells in the RAN, wherein detecting the event or performing the operation includes one or more uplink (UL) listen-before-talk (LBT) failures during random access (RA) procedures on a shared channel;
   in association with detecting the event or performing the operation, storing RA information related to one or more RA procedures performed in respective one or more bandwidth parts (BWPs) of the one or more cells; and
   subsequently sending to a RAN node a message indicating the event or operation, wherein the message includes the RA information.
A2. The method of embodiment A1, wherein:
   the event or operation is a failed mobility operation from a source cell to a target cell;
   the one or more UL LBT failures include one of the following: at least one consistent UL LBT failure in a BWP of the target cell, or more than a threshold number of UL LBT failures in the target cell during the failed mobility operation; and
   the RA information is related to one or more RA procedures performed in respective one or more BWPs of the target cell.
A3. The method of embodiment A2, wherein:
   the failed mobility operation is a dual-active protocol stack (DAPS) handover;
   the one or more UL LBT failures also include one of the following: at least one consistent UL LBT failure in a BWP of the source cell, or more than a threshold number of UL LBT failures in the source cell during the failed mobility operation; and
   the RA information is also related to one or more RA procedures performed in respective one or more BWPs of the source cell.
A4. The method of embodiment A1, wherein:
   the event or operation is a radio-related failure in a serving cell;
   the one or more UL LBT failures include one of the following: at least one consistent UL LBT failure in a BWP of the serving cell, or more than a threshold number of UL LBT failures in the serving cell during the radio-related failure; and
   the RA information is related to one or more RA procedures performed in respective one or more BWPs of the serving cell.
A5. The method of any of embodiments A2-A4, wherein the message is a UEInformationResponse message and the RA information is included a radio link failure (RLF) report information element of the message.
A6. The method of embodiment A1, wherein:
   the event or operation is a successful mobility operation from a source cell to a target cell;
   the one or more UL LBT failures include more than a threshold number of UL LBT failures in the target cell during the successful mobility operation; and
   the RA information is related to one or more RA procedures performed in respective one or more BWPs of the target cell.
A7. The method of embodiment A6, wherein:
   the successful mobility operation is a dual-active protocol stack (DAPS) handover;
   the one or more UL LBT failures also include one of the following: at least one consistent UL LBT failure in a BWP of the target cell, or more than a threshold number of UL LBT failures in the source cell during the successful mobility operation; and
   the RA information is also related to one or more RA procedures performed in respective one or more BWPs of the source cell.
A8. The method of any of embodiments A6-A7, wherein the message is a UEInformationResponse message and the RA information is included a successful handover report (SHR) information element of the message.
A9. The method of embodiment A8, wherein:
   the event or operation is a successful RA procedure in a serving cell;
   the one or more UL LBT failures include at least one consistent UL LBT failure in a BWP of the serving cell before the successful RA procedure; and
   the RA information is related to one or more RA procedures performed in respective one or more BWPs of the serving cell.
A10. The method of embodiment A9, wherein the message is a UEInformationResponse message and the RA information is included a RA report information element of the message.
A11. The method of any of embodiments A1-A10, wherein the RA information includes one the following:
   RA information for an initial RA procedure performed in a cell before detecting the event or during the operation;
   RA information for a final RA procedure performed in a cell before detecting the event or during the operation;
   RA information for only RA procedures performed a cell due to consistent UL LBT failure in another BWP of the cell;
   RA information for only RA procedures performed a cell since a most recent BWP switch in the cell; or
   RA information for a plurality of RA procedures performed in a respective plurality of BWPs of a cell before detecting the event or during the operation.
A12. The method of any of embodiments A1-A11, wherein the RA information for each RA procedure includes one or more of the following information:
   an identity of a BWP in which the RA procedure was performed;
   an indication of whether the BWP was an initial BWP for the cell;
   an indication of whether the BWP was a first active BWP for the cell;
   an indication of whether the RA information was triggered by consistent LBT failure in another BWP of the cell;
   an identity and/or a configuration of another BWP in the cell, in which a RA procedure was most recently performed before the RA procedure in the BWP;
   time elapsed between the most recent RA procedure in another BWP and initiating the RA procedure in the BWP and;
   time elapsed between the most recent BWP switch and initiating the RA procedure in the BWP;
   for each RA transmission during the RA procedure, an indication of whether the transmission was blocked by LBT failure at lower layers;
   time elapsed between different RA transmissions during the RA procedure; and
   one or more LBT-specific configuration parameters for the BWP.
A13. The method of embodiment A12, wherein the RA information also includes one or more of the following:
   an indication that consistent UL LBT failure occurred in the one or more cells before detecting the event or during the operation; and
   a number of consistent UL LBT failures that were triggered and not cancelled at medium access control (MAC) layer in the one or more cells before detecting the event or during the operation.
A14. The method of any of embodiments A12-A13, wherein the time elapsed between different transmissions during the RA procedure include time elapsed between one or more of the following: consecutive msg1 transmissions, consecutive msg3 transmissions, consecutive msgA transmissions, a msg3 transmission and a most recent msg1 transmission, and a msg3 transmission and a most recent msgA transmission.
A15. The method of any of embodiments A1-A14, further comprising:
   sending to the RAN node an indication that the UE has stored RA information in association with the event or operation; and
   receiving from the RAN node a request for the stored RA information,
   wherein the message is sent to the RAN node in response to the request.
B1. A method for a radio access network (RAN) node configured serve user equipment (UEs) via a cell in unlicensed spectrum, the method comprising:
   receiving from a UE a message indicating an event detected by the UE or an operation performed by the UE, wherein:
      the event or operation includes one or more uplink (UL) listen-before-talk (LBT) failures by the UE during random access (RA) procedures on a shared channel, and
      the message includes RA information related to one or more RA procedures performed by the UE in respective one or more bandwidth parts (BWPs) of one or more cells; and
   based on the RA information, adjusting one or more LBT configuration parameters for UEs in a cell served by the RAN node.
B2. The method of embodiment B1, wherein:
   the event or operation is a failed mobility operation from a source cell to a target cell;
   the one or more UL LBT failures include one of the following: at least one consistent UL LBT failure in a BWP of the target cell, or more than a threshold number of UL LBT failures in the target cell during the failed mobility operation; and
   the RA information is related to one or more RA procedures performed in respective one or more BWPs of the target cell.
B3. The method of embodiment B2, wherein:
   the failed mobility operation is a dual-active protocol stack (DAPS) handover;
   the one or more UL LBT failures also include one of the following: at least one consistent UL LBT failure in a BWP of the source cell, or more than a threshold number of UL LBT failures in the source cell during the failed mobility operation; and
   the RA information is also related to one or more RA procedures performed in respective one or more BWPs of the source cell.
B4. The method of embodiment B1, wherein:
   the event or operation is a radio-related failure in a serving cell;
   the one or more UL LBT failures include one of the following: at least one consistent UL LBT failure in a BWP of the serving cell, or more than a threshold number of UL LBT failures in the serving cell during the radio-related failure; and
   the RA information is related to one or more RA procedures performed in respective one or more BWPs of the serving cell.
B5 The method of any of embodiments B2-B4, wherein the message is a UEInformationResponse message and the RA information is included a radio link failure (RLF) report information element of the message.
B6. The method of embodiment B1, wherein:
   the event or operation is a successful mobility operation from a source cell to a target cell;
   the one or more UL LBT failures include more than a threshold number of UL LBT failures in the target cell during the successful mobility operation; and
   the RA information is related to one or more RA procedures performed in respective one or more BWPs of the target cell.
B7. The method of embodiment B6, wherein:
   the successful mobility operation is a dual-active protocol stack (DAPS) handover;
   the one or more UL LBT failures also include one of the following: at least one consistent UL LBT failure in a BWP of the target cell, or more than a threshold number of UL LBT failures in the source cell during the successful mobility operation; and
   the RA information is also related to one or more RA procedures performed in respective one or more BWPs of the source cell.
B8 The method of any of embodiments B6-B7, wherein the message is a UEInformationResponse message and the RA information is included a successful handover report (SHR) information element of the message.
B9. The method of embodiment B8, wherein:
   the event or operation is a successful RA procedure in a serving cell;
   the one or more UL LBT failures include at least one consistent UL LBT failure in a BWP of the serving cell before the successful RA procedure; and
   the RA information is related to one or more RA procedures performed in respective one or more BWPs of the serving cell.
B10. The method of embodiment B9, wherein the message is a UEInformationResponse message and the RA information is included a RA report information element of the message.
B11. The method of any of embodiments B1-B10, wherein the RA information includes one of the following:
   RA information for an initial RA procedure performed in a cell before detecting the event or during the operation;
   RA information for a final RA procedure performed in a cell before detecting the event or during the operation;
   RA information for only RA procedures performed a cell due to consistent UL LBT failure in another BWP of the cell;
   RA information for only RA procedures performed a cell since a most recent BWP switch in the cell; or
   RA information for a plurality of RA procedures performed in a respective plurality of BWPs of a cell before detecting the event or during the operation.
B12. The method of any of embodiments B1-B11, wherein the RA information for each RA procedure includes one or more of the following information:
   an identity of a BWP in which the RA procedure was performed;
   an indication of whether the BWP was an initial BWP for the cell;
   an indication of whether the BWP was a first active BWP for the cell;
   an indication of whether the RA information was triggered by consistent LBT failure in another BWP of the cell;
   an identity and/or a configuration of another BWP in the cell, in which a RA procedure was most recently performed before the RA procedure in the BWP;
   time elapsed between the most recent RA procedure in another BWP and initiating the RA procedure in the BWP and;
   time elapsed between the most recent BWP switch and initiating the RA procedure in the BWP;
   for each RA transmission during the RA procedure, an indication of whether the transmission was blocked by LBT failure at lower layers;
   time elapsed between different RA transmissions during the RA procedure; and
   one or more LBT-specific configuration parameters for the BWP.
B13. The method of embodiment B12, wherein the RA information also includes one or more of the following:
   an indication that consistent UL LBT failure occurred in the one or more cells before detecting the event or during the operation; and
   a number of consistent UL LBT failures that were triggered and not cancelled at medium access control (MAC) layer in the one or more cells before detecting the event or during the operation.
B14. The method of any of embodiments B12-B13, wherein the time elapsed between different transmissions during the RA procedure include time elapsed between one or more of the following: consecutive msg1 transmissions, consecutive msg3 transmissions, consecutive msgA transmissions, a msg3 transmission and a most recent msg1 transmission, and a msg3transmission and a most recent msgA transmission.
B15. The method of any of embodiments B1-B14, further comprising:
   receiving from the UE an indication that the UE has stored RA information in association with the event or operation; and
   sending to the UE a request for the stored RA information,
   wherein the message is received from the UE in response to the request.
B16. The method of any of embodiments B1-B15, wherein adjusting one or more LBT configuration parameters for UEs based on the RA information comprises one or more of the following:
   determining one or more of the following information based on the RA information:
      BWPs in which the UE experienced consistent UL LBT failure;
      how many BWP switches were performed by the UE due to consistent UL LBT failures;
      one or more types of UE RA transmissions that resulted in UL LBT failures;
      which portion of the UE's reported LBT failures occurred during RA procedures in the shared channel; and
   adjusting RA configurations in BWPs in which the UE experienced consistent UL LBT failure, based on the determined information.
C1. A user equipment (UE) configured to operate in unlicensed spectrum in a radio access network (RAN), the UE comprising:
   communication interface circuitry configured to communicate with at least one RAN node; and
   processing circuitry operatively coupled to the communication interface circuitry, whereby the processing circuitry and the communication interface circuitry are configured to perform operations corresponding to the methods of any of embodiments A1-A15.
C2. A user equipment (UE) configured to operate in unlicensed spectrum in a radio access network (RAN), the UE being further arranged to perform operations corresponding to the methods of any of embodiments A1-A15.
C3. A non-transitory, computer-readable medium storing computer-executable instructions that, when executed by processing circuitry of a user equipment (UE) configured to operate in unlicensed spectrum in a radio access network (RAN), configure the UE to perform operations corresponding to the methods of any of embodiments A1-A15.
C4. A computer program product comprising computer-executable instructions that, when executed by processing circuitry of a user equipment (UE) configured to operate in unlicensed spectrum in a radio access network (RAN), configure the UE to perform operations corresponding to the methods of any of embodiments A1-A15.
D1. A radio access network (RAN) node configured to serve user equipment (UEs) via a cell in unlicensed spectrum, the RAN node comprising:
   communication interface circuitry configured to communicate with UEs; and
   processing circuitry operatively coupled to the communication interface circuitry, whereby the processing circuitry and the communication interface circuitry are configured to perform operations corresponding to the methods of any of embodiments B1-B16.
D2. A radio access network (RAN) node configured to serve user equipment (UEs) via a cell in unlicensed spectrum, the RAN node being further arranged to perform operations corresponding to the methods of any of embodiments B1-B16.
D3. A non-transitory, computer-readable medium storing computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B16.
D4. A computer program product comprising computer-executable instructions that, when executed by processing circuitry of a radio access network (RAN) node configured to serve user equipment (UEs) via a cell in unlicensed spectrum, configure the RAN node to perform operations corresponding to the methods of any of embodiments B1-B16.

1.-47. (canceled)

48. A method for a user equipment (UE) configured to operate in unlicensed spectrum in a radio access network (RAN), the method comprising:
detecting an event or performing an operation involving one or more cells in the RAN, wherein detecting the event or performing the operation includes one or more uplink (UL) listen-before-talk (LBT) failures during random access (RA) procedures on a shared channel;
in association with detecting the event or performing the operation, storing RA information associated with one or more RA procedures performed in respective one or more bandwidth parts (BWPs) of the one or more cells; and
subsequently sending to a RAN node a message indicating the event or operation, wherein the message includes the RA information.

49. The method of claim 48, wherein:
the event or operation is a failed mobility operation from a source cell to a target cell;
the one or more UL LBT failures include one of the following: at least one consistent UL LBT failure in a BWP of the target cell, or more than a threshold number of UL LBT failures in the target cell during the failed mobility operation; and
the RA information is associated with one or more RA procedures performed in respective one or more BWPs of the target cell.

50. The method of claim 49, wherein:
the failed mobility operation is a dual-active protocol stack (DAPS) handover;
the one or more UL LBT failures also include one of the following: at least one consistent UL LBT failure in a BWP of the source cell, or more than a threshold number of UL LBT failures in the source cell during the failed mobility operation; and
the RA information is also associated with one or more RA procedures performed in respective one or more BWPs of the source cell.

51. The method of claim 48, wherein:
the event or operation is a radio-related failure in a serving cell;
the one or more UL LBT failures include one of the following: at least one consistent UL LBT failure in a BWP of the serving cell, or more than a threshold number of UL LBT failures in the serving cell during the radio-related failure; and
the RA information is associated with one or more RA procedures performed in respective one or more BWPs of the serving cell.

52. The method of claim 48, wherein:
the event or operation is a radio link failure (RLF) in a serving cell; and
the RA information is associated with a last one of multiple RA procedures the UE performed in one of the BWPs of the serving cell.

53. The method of claim 49, wherein the message is a UEInformationResponse message and the RA information is included a radio link failure (RLF) report information element of the message.

54. The method of claim 48, wherein:
the event or operation is a successful mobility operation from a source cell to a target cell; and
the RA information is associated with a last one of multiple RA procedures the UE performed in one of the BWPs of the target cell.

55. A method for a radio access network (RAN) node configured to serve user equipment (UEs) via a cell in unlicensed spectrum, the method comprising:
receiving from a UE a message indicating an event detected by the UE or an operation performed by the UE, wherein:
the event or operation includes one or more uplink (UL) listen-before-talk (LBT) failures by the UE during random access (RA) procedures on a shared channel; and
the message includes RA information associated with one or more RA procedures performed by the UE in respective one or more bandwidth parts (BWPs) of one or more cells; and
based on the RA information, adjusting one or more LBT configuration parameters for UEs in a cell served by the RAN node.

56. The method of claim 55, wherein:
the event or operation is a failed mobility operation from a source cell to a target cell;
the one or more UL LBT failures include one of the following: at least one consistent UL LBT failure in a BWP of the target cell, or more than a threshold number of UL LBT failures in the target cell during the failed mobility operation; and
the RA information is associated with one or more RA procedures performed in respective one or more BWPs of the target cell.

57. The method of claim 56, wherein:
the failed mobility operation is a dual-active protocol stack (DAPS) handover;
the one or more UL LBT failures also include one of the following: at least one consistent UL LBT failure in a BWP of the source cell, or more than a threshold number of UL LBT failures in the source cell during the failed mobility operation; and
the RA information is also associated with one or more RA procedures performed in respective one or more BWPs of the source cell.

58. The method of claim 55, wherein:
the event or operation is a radio-related failure in a serving cell;
the one or more UL LBT failures include one of the following: at least one consistent UL LBT failure in a BWP of the serving cell, or more than a threshold number of UL LBT failures in the serving cell during the radio-related failure; and
the RA information is associated with one or more RA procedures performed in respective one or more BWPs of the serving cell.

59. The method of claim 55, wherein:
the event or operation is a radio link failure (RLF) in the serving cell; and
the RA information is associated with a last one of multiple RA procedures the UE performed in one of the BWPs of the serving cell.

60. The method of claim 55, wherein the message is a UEInformationResponse message and the RA information is included a radio link failure (RLF) report information element of the message.

61. The method of claim 55, wherein:
the event or operation is a successful mobility operation from a source cell to a target cell; and
the RA information is associated with a last one of multiple RA procedures the UE performed in one of the BWPs of the target cell.

62. The method of claim 55, wherein adjusting one or more LBT configuration parameters for UEs based on the RA information comprises:
determining one or more of the following information based on the RA information:
BWPs in which the UE experienced consistent UL LBT failure;
how many BWP switches were performed by the UE due to consistent UL LBT failures;
one or more types of UE RA transmissions that resulted in UL LBT failures;
which portion of the UE's reported LBT failures occurred during RA procedures in the shared channel; and
adjusting RA configurations in BWPs in which the UE experienced consistent UL LBT failure, based on the determined information.

63. User equipment (UE) configured to operate in unlicensed spectrum in a radio access network (RAN), the UE comprising:
communication interface circuitry configured to communicate with at least one RAN node; and
processing circuitry operatively coupled to the communication interface circuitry, wherein the processing circuitry and the communication interface circuitry are configured to:
detect an event or perform an operation involving one or more cells in the RAN, wherein detecting the event or performing the operation includes one or more uplink (UL) listen-before-talk (LBT) failures during random access (RA) procedures on a shared channel;
in association with detecting the event or performing the operation, store RA information associated with one or more RA procedures performed in respective one or more bandwidth parts (BWPs) of the one or more cells; and
subsequently send to the RAN node a message indicating the event or operation, wherein the message includes the RA information.

64. The UE of claim 63, wherein:
the event or operation is a failed mobility operation from a source cell to a target cell;
the one or more UL LBT failures include one of the following: at least one consistent UL LBT failure in a BWP of the target cell, or more than a threshold number of UL LBT failures in the target cell during the failed mobility operation; and
the RA information is associated with one or more RA procedures performed in respective one or more BWPs of the target cell.

65. Non-transitory, computer-readable medium storing computer-executable instructions that, when executed by processing circuitry of user equipment (UE), configure the UE to perform the method of claim 48.

66. Radio access network (RAN) node configured to serve user equipment (UEs) via a cell in unlicensed spectrum, the RAN node comprising:
communication interface circuitry configured to communicate with UEs via the cell; and
processing circuitry operatively coupled to the communication interface circuitry, wherein the processing circuitry and the communication interface circuitry are configured to:
receive from a UE a message indicating an event detected by the UE or an operation performed by the UE, wherein:
the event or operation includes one or more uplink (UL) listen-before-talk (LBT) failures by the UE during random access (RA) procedures on a shared channel; and
the message includes RA information associated with one or more RA procedures performed by the UE in respective one or more bandwidth parts (BWPs) of one or more cells; and
based on the RA information, adjust one or more LBT configuration parameters for UEs in a cell served by the RAN node.

67. The RAN node of claim 66, wherein:
the event or operation is a failed mobility operation from a source cell to a target cell;
the one or more UL LBT failures include one of the following: at least one consistent UL LBT failure in a BWP of the target cell, or more than a threshold number of UL LBT failures in the target cell during the failed mobility operation; and
the RA information is associated with one or more RA procedures performed in respective one or more BWPs of the target cell.

68. Non-transitory, computer-readable medium storing computer-executable instructions that, when executed by processing circuitry of a radio access network (RAN) node, configure the RAN node to perform the method of claim 55.
